(19) United States
(12) Patent Application Publication
(10) Pub. No.: US 2012/0265618 A1
(43) Pub. Date: Oct. 18, 2012

(54) SYSTEM AND METHOD FOR MONETIZING ON-LINE USER-GENERATED CONTENT

(76) Inventor: Roddy M. Bullock, Milford, OH (US)

(21) Appl. No.: 13/531,581

(22) Filed: Jun. 24, 2012

Related U.S. Application Data
(62) Division of application No. 12/636,731, filed on Dec. 12, 2009.
Application No. 12/636,731 is a continuation-in-part of application No. 12/492,132, filed on Jun. 25, 2009.
Application No. 12/492,132 is a continuation-in-part of application No. 12/479,780, filed on Jun. 6, 2009, now Pat. No. 8,065,193.

(51) Int. Cl. G06Q 30/02

(52) U.S. Cl. 705/14.64; 705/14.73

(57) ABSTRACT

A method and system for generating revenue on the internet by an internet content provider. The method can include the steps of publishing content on a web page accessible via a web browser; providing on the web page a first area for at least one user-generated default-format comment; providing on the web page a second area for an advertisement; providing on the web page a third area for at least one fee-paid comment; displaying on the web page in the first area at least one of the user-generated default-format comment; displaying on the web page in the second area at least one advertisement; and displaying on the web page in the third area at least one fee-paid comment. Readers of the content can read the default-format comment, the advertisement, and the fee-paid comment on the same web page.

### CROSS-REFERENCE TO OTHER APPLICATIONS

This application is a Divisional of U.S. application Ser. No. 12/636,731, filed Dec. 12, 2009, entitled System and Method for Making Money by Facilitating Easy Online Payment, and claims priority as a continuation-in-part to U.S. Ser. No. 12/492,132, entitled Universal One-Click Online Payment Method and System, filed Jun. 25, 2009, and U.S. Ser. No. 12/479,780, issued as U.S. Pat. No. 8,065,193, entitled Method for Making Money on the Internet, filed Jun. 6, 2009, each of which is hereby incorporated herein by reference.

### FIELD OF THE INVENTION

This invention relates to a method for monetizing online content on the internet.

### BACKGROUND OF THE INVENTION

The internet is the main source of news and information for growing numbers of people. Mainstream media news organizations, niche news outlets, and alternative viewpoint news sources all maintain news content on websites. In addition to news, the internet has fostered the growth and popularity of “web logs” or “blogs” run by “bloggers” as sources of news and information.

One problem with the internet as a source of news and information is that it is difficult for news organizations or bloggers to generate revenue. Popular sites can attract paying advertisers, but in the current internet environment the sheer number of websites offering news and information makes the pool of advertising dollars insufficient to bring in satisfying revenue for many. Additionally, some websites or blogs have very loyal, but very limited readership, so that the size of the reading audience makes the website unattractive to advertisers or otherwise monetize their efforts.

There is a continuing unmet need for a method for internet content providers, such as organizations with websites, individuals or groups with blogs, and syndicated news organizations to generate revenue, or additional revenue, for the content provided to the public.

Many websites provide news and information content with a provision for the reader to leave comments. For example, a news story can include a place, usually at the end of the article, for the user to post his or her comments. Sometimes the user must first register, but other times the user simply leaves a comment pursuant to the instructions given. Likewise, many blogs provide the opportunity for readers to comment. Again, the person commenting may have to first register, but not always. Sometimes comments are moderated, which means they can be first checked for content before posting publicly on the website.

Popular or controversial news stories or blog entries can generate many hundreds of comments. Comments are usually posted in chronological order, and can be ranked or emailed by readers. Sometimes comments are posted in non-chronological order, such as by “most popular” or “most emailed”. Sometimes the comment section is set up to allow comments on comments, with those readers submitting comments, i.e., commenters, often generating a line of thought that can be independent of the original story.

A reader of a news story or blog often checks the comments, but may not read down more than a few comments, and may read only the first and last comments. Many comments go unread for lack of visibility, that is, they are in essence “buried” in the multitude of other comments. Many readers and commenters (i.e., readers who leave comments) alike can find the lack of attention to particular comments to be frustrating. For example, a reader who wishes to leave what the reader perceives to be a particularly salient comment may be frustrated by the knowledge that her comment might be in the middle of hundreds of others, thereby making it highly unlikely to be read by anyone.

There is a continuing unmet need for a way to permit commenters on news stories or blog entries to get their comments noticed.

Often internet content providers offer readers the opportunity to purchase goods or services. Various methodologies and systems are currently known and used to effect commerce via electronic means such as the internet. Because of security concerns, known services require user names and passwords, or the entry of personal information such as credit card data each time a financial transaction is made, making transactions cumbersome for readers. For example, it is believed that the popular online system PAYPAL® requires users, in addition to an initial registration, to enter a user name and password upon each use of the its service. For occasional users this is a hindrance to quickly transacting business, and for low-cost goods or services, the hindrance can be prohibitively high, keeping some users from completing a transaction. Other services, such as APPLE® computer's popular iTunes® music are believed to utilize the so-called “one-click” technology pioneered by Amazon.com, which is believed to map a server-assigned client identifier to a purchaser, which thereafter permits purchase completion based on purchaser-specific information already stored at the server system. However, it is believed that current “one-click” technology nevertheless requires the user to log on with a user name and password if the user is not using a computer having a file called a “cookie” in which is the assigned client identifier. And, it is believed, even when the user is on a computer having a sufficient file having the required cookie, the user is nevertheless required to enter a password prior to completing a purchase of goods or services from the internet content provider.

There is a continuing unmet need for an easy, quick, and relatively secure, i.e., relatively low risk, methodology for effecting electronic commerce utilizing the internet.

As more and more consumers purchase via the internet, many consumers would like to complete online financial transactions without navigating a burdensome payment system. Particularly for small purchase amounts, consumers would like to avoid the hassle of, as one report put it, “today's clunky payment systems”. Due to the scale achievable on the internet, purchase amounts in the sub-dollar range can potentially generate high revenues, but such “micropayments”, as they are termed in the industry, are likely to be made only when the transaction cost of time and effort is low. Previous attempts at effecting efficient online micropayments, such as Flooz, Beenz, CyberCash, Bitpass, Peppercoin and DigiCash have all been unsuccessful.

There is a continuing unmet need for an effective method for facilitating online micropayments.

### SUMMARY OF THE INVENTION

A method and system for generating revenue on the internet by an internet content provider is disclosed. The method can include the steps of:
a. publishing content on a web page accessible via a web browser;
b. providing on the web page a first area for at least one user-generated default-format comment;
c. providing on the web page a second area for an advertisement;
d. providing on the web page a third area for at least one fee-paid comment;
e. displaying on the web page in the first area at least one of the user-generated default-format comment;
f. displaying on the web page in the second area at least one advertisement;
g. displaying on the web page in the third area at least one fee-paid comment; and
   wherein readers of the content can read the default-format comment, the advertisement, and the fee-paid comment on the same web page.

### BRIEF DESCRIPTION OF THE DRAWINGS

FIG. 1 is a flowchart description of one system and method of the present invention.

FIG. 2 is a flowchart description of one system and method of the present invention.

FIG. 3 is a flowchart description of one system and method for enabling electronic payment utilizing the internet.

FIGS. 4-6 are a flowchart description of one system and method of effecting an electronic commerce transaction utilizing the internet.

FIG. 7 is a flowchart description of one system and method of the present invention.

FIG. 8 shows an exemplary screen view of a website offering news or blog internet content and a comments section.

FIG. 9 shows an exemplary screen view of a website implementing an embodiment of the present invention.

FIG. 10 shows an exemplary screen view of a website implementing an embodiment of the present invention.

FIG. 11 is a schematic block diagram of a computer operable to execute the disclosed invention.

FIG. 12 is a schematic block diagram of an exemplary computing environment suitable for the present invention.

FIG. 13 shows an exemplary screen view of a website implementing an embodiment of the present invention.

### DETAILED DESCRIPTION OF THE INVENTION

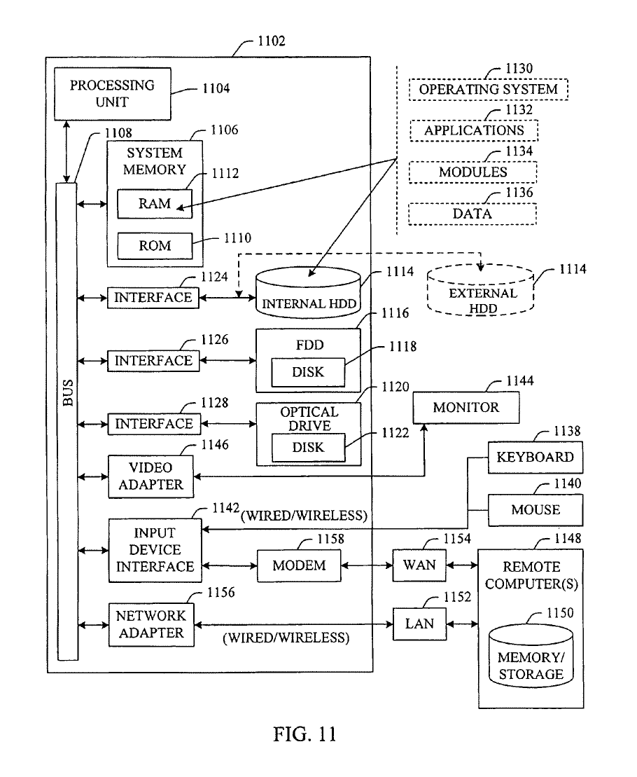

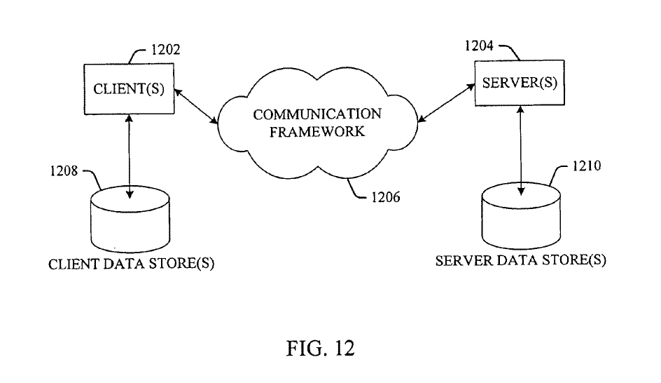

The method of the present invention has as an object the making of money using the internet. As used herein the term internet is used in its normal usage to be the system, including the World Wide Web by which content providers, such as news sites, blogs and online merchants can supply web content, such as from a news server, to be displayed, or published, on internet connected client (or reader) computers operable to access and display the content via a web browser. Therefore, computers, networks, internet connections, operating systems, programs, data structures, processing units, system memory components, system busses, wireless connections, cookies, mobile devices such as Blackberries®, iPhones®, and other computing hardware and software as known in the art for internet communication can be utilized in the present invention. By way of further example, a computer and computing environment suitable for practicing the present invention is described in U.S. Ser. No. 11/197,067, published Feb. 15, 2007 as US 2007/0038646, entitled Ranking Blog Content, and particularly paragraphs to [0102] and FIGS. 11 and 12. Likewise, a method and system for placing an order via the internet can be practiced according to that disclosed in U.S. Pat. No. 5,960,411, granted Sep. 28, 199. Thus, without being bound by theory, or limited by lack of precise jargon, the description of the invention below is intended to be understood as being operable in the context of known means for operating websites, payment systems, computers, servers, and user-generated content, all as currently used for internet activity, but lacking in the inventive features of the present invention.

In the following description, for purposes of explanation, numerous specific details are set forth in order to provide a thorough understanding of the subject invention. It may be evident, however, that the invention can be practiced without some of these specific details.

The method of the invention allows willing readers to pay a fee for having posted comments to an online publication of an internet content provider rendered distinctive, the distinctive comments being altered from a default comment format so that the altered comments are distinctive relative to a default format. Readers can comment on a news story or blog entry, and the like, whether or not they read the online publication to which comments are associated. Readers can also be people who wish to alter for distinctiveness a comment of another. In this manner, readers desiring that the reading public read their comment, or the comment of another, can, by paying a fee to the internet content provider or a third party on behalf of the internet content provider, have a comment visibly changed in its online published format so as to make it stand out from the comments posted in a free default format. The transformation of a comment from a default format to a distinctive format, such as by altering the appearance or placement of a comment, can be achieved by means known in the art, including by manually cutting and pasting the paid-for comment into a comment position or field associated with a first comment, or by means of computer executable instructions controlled by a suitably programmed processor utilizing stored memory.

Payment for having posted comments rendered distinctive can be accomplished by known methods. However, recognizing that in many cases the fee for such services by an internet content provider is likely to be relatively small, the present invention contemplates a method and system for making the transaction quick and easy. For web-browsing readers, particularly readers commenting on a news story, blog, or other internet content provider's site, such as DIGG® and other such news ranking sites, speed and ease are important. In one sense, for readers commenting on the internet, instant gratification is important. If a reader is required to enter in personal information such as name, address, email, credit card number, and the like, the reader is not likely to complete a purchase for a relatively modest amount. As fully described below, the present invention solves the problem of cumbersome purchase steps, offering the reader quick and easy purchasing of goods and services utilizing the internet.

“Internet content provider” as used herein refers to individuals, organizations, corporations, or other entities that utilize computers or computer systems to publish content on the internet for reading by those connected to the internet via web browsers operating on computers. Thus, for example, CNN is an internet content provider, providing news stories via the URL www.cnn.com to readers who enter the URL into the web browser on their personal computers. Similarly, The Huffington Post is an internet content provider, providing commentary in the form of a web log, or “blog” via the URL www.thehuffingtonpost.com to readers who enter the URL into the web browser on their personal computers. Readers can subscribe to internet content providers via syndication feeds, and individual URLs can be stored via browser “bookmark” or “favorites” utilities.

“Comment” or “comments” as used herein refers, in context, to the expression of the thoughts and/or opinion that a reader writes and/or posts in commentary, letters, and the like, for publication in the section of an internet content provider's web content that is intended for reader comments. The expression can take the form of text, as in letters, words and sentences, images, as in digital photos and videos, sounds, as in audio recordings, graphical descriptions, advertising, URL links, and combinations thereof. “Comments” or “comment section” also refers, in context, to the portion of a section of an internet content provider's website intended to contain the expression of readers' posted thoughts and/or opinion. Comments, therefore, are simply a form of user-generated content.

In prior art comment sections, the appearance or placement (relative to other comments and/or relative to the web page on which they appear) of the comment as publicly posted was not in the commenter's control. After submitting the comment it would show up posted in a default format utilized by the website or content provider, including, usually, in a chronological or reverse-chronological order with the time and date displayed. In some instances, the internet content provider permits certain html-code commands, and other limited textual commands to render text as bold, italics, and the like, all of which is not considered to be modified or altered to be conspicuous or distinctive within the scope of the present invention.

“Default format” as used herein with respect to the format of the comment section of an internet providers' story or blog entry, refers to a typical or standard format for comments utilized by a news site or a blog for which no fee is received from the commenter, and which format can, according to the present invention, be modified or altered by payment of a fee as disclosed herein.

“Commenter” as used herein is one who makes, leaves, or posts a comment on a page of an internet content provider. “Reader” when used in context of one who wishes to leave a comment is synonymous with commenter.

“Payer” as used herein is a person, company, or other entity controlling a payment account from which monetary funds can be dispersed or otherwise debited for goods or services. As used herein, a payment account controlled by a payer, such as an individual checking account, individual debit account, individual credit card, company credit or checking account, or the like, for which the payer is an account holder or is otherwise authorized to control the account, is said to be “associated with” the payer.

“Payee” as used herein is a person, company, or other entity controlling a receiving account to which monetary funds can be paid or otherwise credited for goods or services. As used herein, a receiving account is “associated with” an online merchant such as an internet content provider, if the account is owned or controlled by the internet content provider or owned or controlled by an entity in the internet content provider's trust.

In one embodiment, the internet content provider can be a news organization, providing news stories. In another embodiment, the internet content provider can be a blogger, providing opinion and other information, including news, on a blog. In either embodiment, whether it be a news story, a blog entry, or other information, the internet content provider can make provision for readers to leave an online comment, with an added provision of facilitating or permitting payment of a fee in exchange for having the reader's comment rendered more conspicuous and distinctive by altering or modifying it relative to a free default format, and/or by placing it in a distinctive position on a web page relative to other comments which may or may not be in a free default format. The online comment can comprise any user-generated content the internet content provider is willing to accept, including text, as in letters, words and sentences, images, as in digital photos and videos, sounds, as in audio recordings, graphical descriptions, advertising, URL links, and combinations thereof.

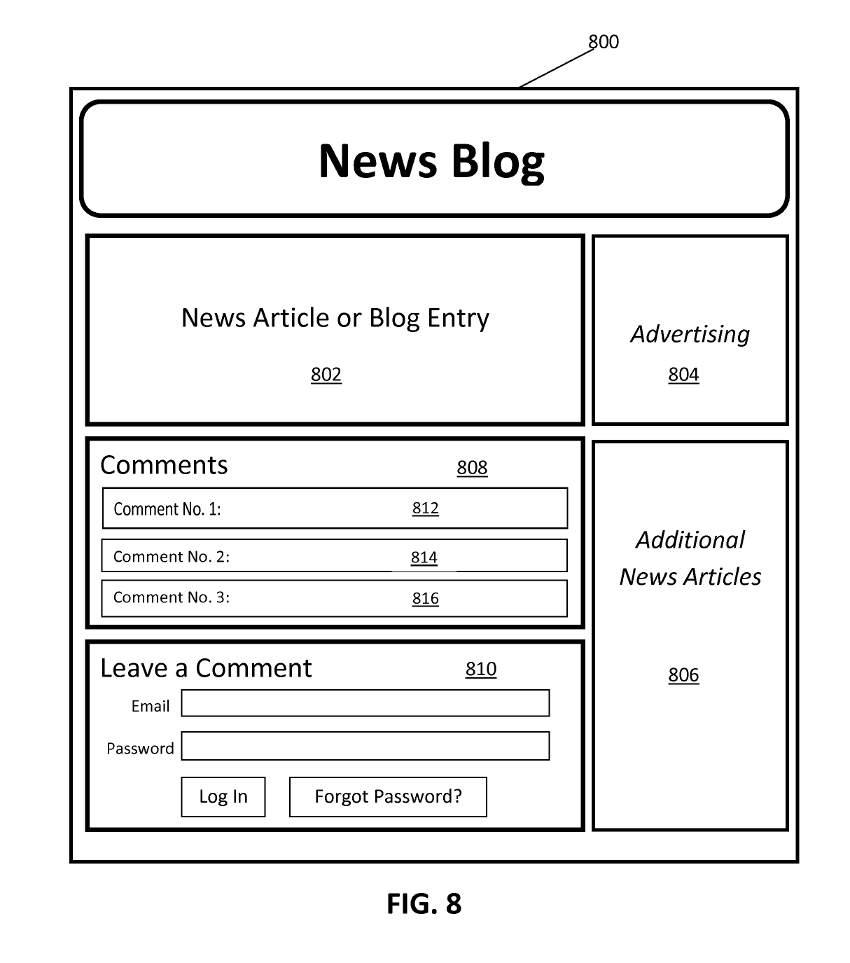

In one embodiment, a news story or blog entry can have associated therewith, for example, at the end thereof, a section for readers to leave comments. Such comment sections and reader-generated comments, as discussed below with respect to FIG. 8, are currently used by online content providers, and comments can include messages, URL addresses, video links, quoted material, letters, letters to the editor, and the like. Such comments are currently known to be posted in a default format for free, either with or without first registering, and either with or without moderation of the comment.

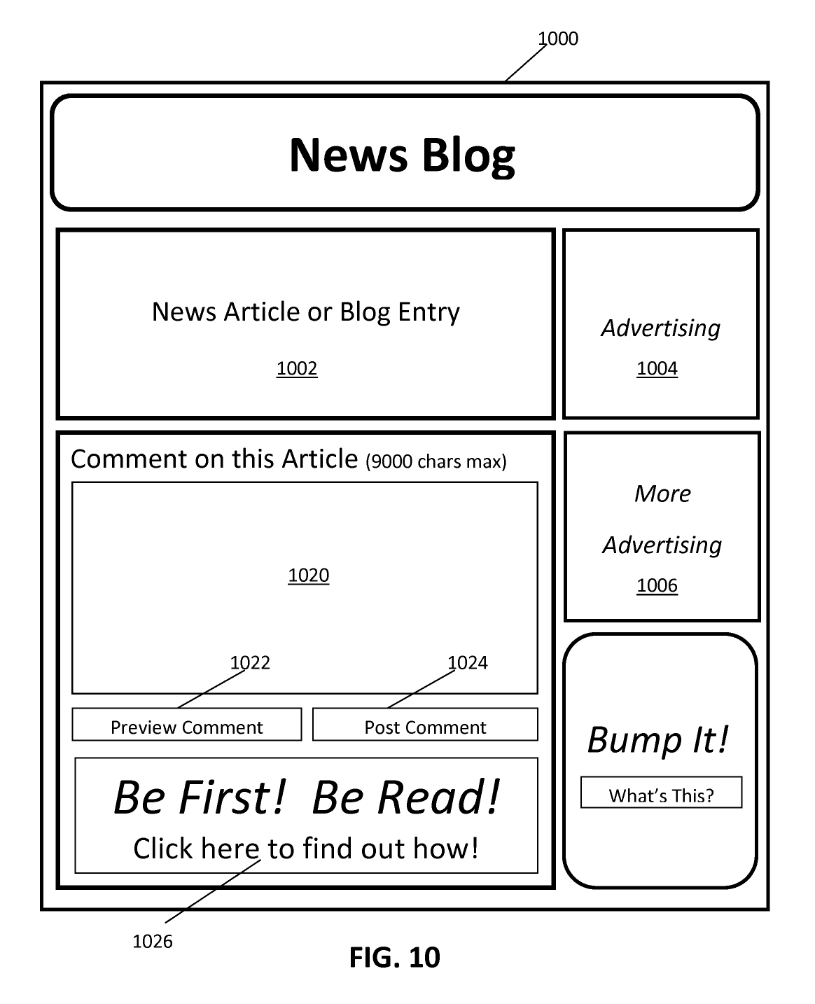

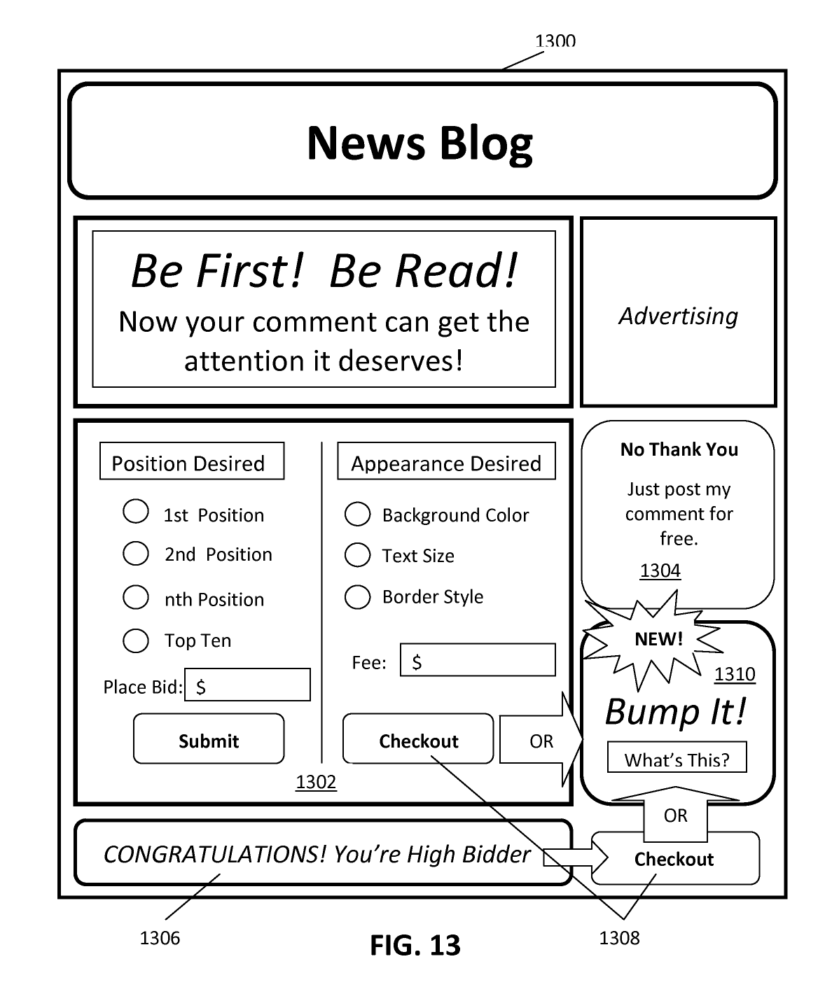

The present invention provides for a solution to an internet content provider's problem of lack of sufficient revenue, and at the same time, indulges a reader's desire to have his or her comment made more prominent, by providing for a fee payment from the reader to the internet content provider, or a predetermined third party handling the internet content provider's financial transaction, in exchange for the internet content provider posting the reader's comment in a distinctive manner. In one embodiment, as discussed below with respect to FIGS. 10 and 13, after the reader types out a comment, the reader can be prompted by an on screen prompt to pay a fee in exchange for the reader's comment to be modified from the standard or default format used for free (i.e., cost free, no fee paid by the reader) comments by making it distinctively different from other comments and/or placing it in a distinctive location or position relative to other comments. For example, for a fee, the internet content provider can keep a reader's comment as the first comment after a news story, regardless of the otherwise chronological timing of the posting.

In one embodiment, the reader can agree to pay a fee, and can pay the fee from a payment account via known methods of fee payment, such as by online credit card, online secure credit payment, PAYPAL®, and, for all embodiments described herein, online payment methods functionally equivalent to PayPal® such as Amazon™ PayPhrase, Amazon™ Simple Pay, Checkout by Amazon, and Google® Checkout. The reader's payment account can be a debit account or a checking account. The fee can be deposited into the internet content provider's receiving account, or a receiving account of a third party charged with receiving fees for the internet content provider. Any known online payment system can be used to allow the reader to pay a fee to the internet content provider or a predetermined third party. In one embodiment, for certain readers of a news site or blog, the internet content provider can set up, and the reader can subscribe to, a personal deposit account with money deposited therein by the reader from which the reader can instruct the news site or blog to deduct payment upon instruction by the reader to do so. As well, payment for goods or services utilizing the internet can be effected by the method and system disclosed more fully below, in which a purchaser can make purchases quickly and easily without necessarily having to input at the time of purchase credentials such as a username or password.

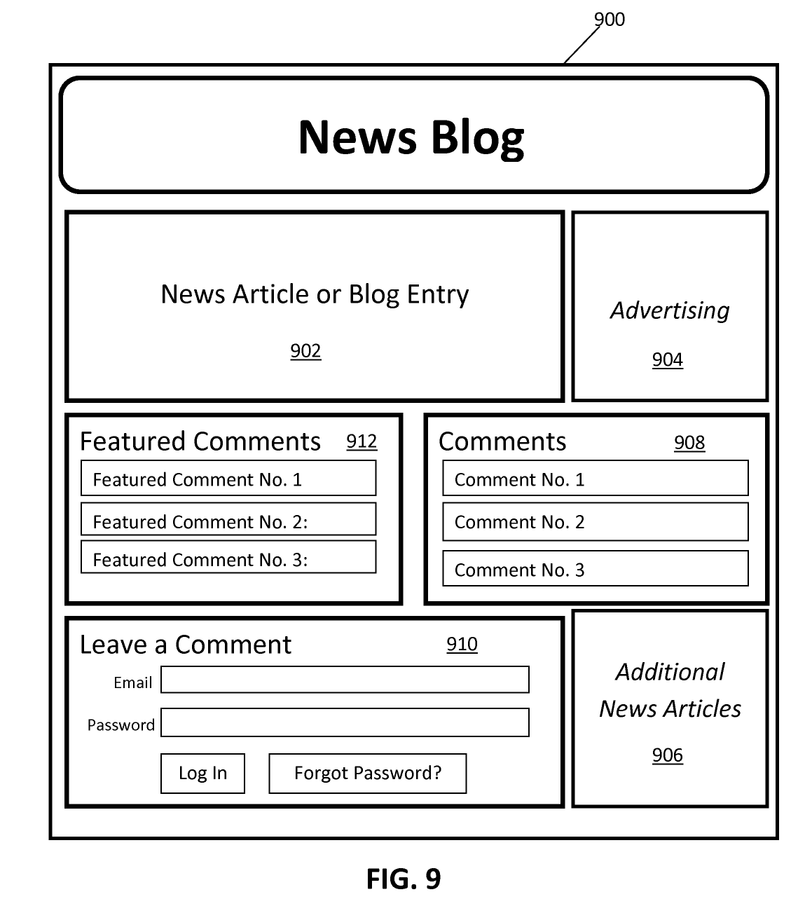

In one embodiment, in exchange for a fee paid by the reader, the reader's comment, letter, or the like can be posted in a condition altered from a free (no cost or fee) default format by use of, for example, a distinctive background, background color, border, border colors, text, text color, text font, text font size, and combinations thereof. For example, after paying a fee, the reader's comment, letter, photo, or the like can be displayed among the free default-format comments, with a distinctive background color, a distinctive border, larger font text, and combinations thereof. Similarly, after paying a fee, the reader's comment, letter, photo or the like can be posted in a different position or location relative to the free default-format comments. The different position or location can be a prominent, non-chronological placement with other comments, or as described below with respect to FIG. 9, a separate place on the web page with other comments, or on a separate web page. In this way of monetizing internet content, the public is benefited by an open market system that permits readers to satisfy their desire to be distinctive, while simultaneously providing revenue to the internet content provider, who can continue to provide valuable information to the public without charge.

In one embodiment, in exchange for a fee paid by the reader, the reader's comment can be altered from a free default format by allowing the user to customize the comment with the reader's choice of color, style, and/or size of various components of the comment.

In one embodiment, a specified distinctiveness, such as a distinctive appearance and/or position in a comments section or a distinctive appearance and/or position on a web page, can be auctioned off, similar to how items are auctioned on popular websites such as eBay®. For example, highly visible or otherwise well-placed comments, such as the first comment to appear after a news story or blog entry, or a separately displayed comment on a web page, can be auctioned to a highest bidder. In such an embodiment, as described below with respect to FIG. 13, a reader can place a bid for a specified position, such as the first comment to appear after a news story or blog entry, or any other designated spot. Upon placing the bid, the reader can be notified, either manually by a human website monitor, or automatically via software designed to handle bids such as that used by eBay® and the like, if he is the top bidder. Upon such notification, if he is not the high bidder, the reader can decide if he will raise (or “up”) the bid so as to gain the desired spot, or take other action. If he is the high bidder, his comment will be posted in the bid-for distinctiveness. Additionally, the internet content provider can provide an option for the high bidder to be notified if another reader bids higher, thereby displacing his comment from its specified distinctiveness.

In one embodiment, the order or placement of distinctive comments can be according to the fee paid. Thus, in an auction-type environment, the current high bidding commenter can have his or her comment placed in a most distinctive manner, such as being the first comment to appear after a news story. The next highest bidder can have his or her comment placed in the second most distinctive manner, such as being the second comment to appear after a news story. In this way, the public is benefited by an open market “bidding war” that permits readers to satisfy their desire to be most distinctive, while simultaneously providing revenue to the internet content provider, who can continue to provide valuable information to the public without charge.

In one embodiment, a bidder can bid for a specified position. For example, a bidder can bid to be the third comment down from the top, knowing that the third comment position will still be readily visible to readers, but less expensive than the first or second comment spots. In this embodiment, the commenter first specifies what position is desired, and bids against a commenter who already occupies the specified position. Thus, if the website configuration is such that ten comments appear on the page on which a news story or blog entry ends, commenters can bid and/or pay for any of the ten comment positions, knowing that even the tenth position will still show on the first page readers are confronted with after reading the news or blog item.

In one embodiment the internet content provider can guarantee a minimum or maximum time in a distinctive position for the fee received. Once the set time period expires, another reader can purchase the position for another set time period. In this manner, more than one reader can have his or her comment placed in a desirably distinctive position.

In one embodiment, a specified distinctiveness, such as a distinctive appearance and/or position in a comments section or a distinctive appearance and/or position on a web page, can be bid for, either by fixed price or by auction, for fixed time with a predetermined start time and stop time. In this manner, readers can bid for predictable timing of the exposure of their comments.

In one embodiment, a specified distinctiveness, such as a distinctive appearance and/or position in a comments section or a distinctive appearance and/or position on a web page, can be shared with other distinctive comments, such as in a special location on a web page, set apart from the free default-format comments. For example, in one embodiment, as shown in FIG. 9, the web page can have two “windows”, one of which is used for fee-paid comments, and which can appear immediately after a news story or blog entry, and the other of which is used for free, default-format comments, and appears much as current comment sections currently appear.

In one embodiment an internet content provider can limit a comment section entirely to paid comments. For example, in one embodiment payment of a fee is a prerequisite for posting any comments. Once a fee is paid by the payer to the payee, the internet content provider posts the comment to the comment section.

In one embodiment, the paid-for distinctiveness can be placement on the first page of comments. In one embodiment the comment section on a page, such as the first page, of comments can include both free default-format comments and fee-paid, distinctive comments, and can be divided between free default-format comments, and fee-paid, distinctive comments. For example, to avoid dis-incentivizing readers who wish to leave free comments, the first comments to appear after a news story or blog entry can be free default-format comments which are followed by fee-paid comments. In this manner, people wishing to post free comments still have the opportunity to have the first, just as they would in the absence of fee-paid comments, and the paid comments still enjoy the luxury of being, and remaining, on the first page of comments. Thus, if the internet content provider's website is designed to display n comments on a page, such as the first page to appear after a news story, the first m<n comments can be free, and the remaining p=(n−m) comments can be fee paid comments. Likewise, the internet content provider can choose to have the reverse arrangement, wherein on the first page to follow a news story there are n comments, and the last m<n comments are free, default format comments, and the first p=(n−m) comments are fee-paid comments.

By way of example, currently the popular political website www.politico.com features a link at the end of news stories to “show the first 20 comments”. Upon clicking the link the reader is directed to a page with the first twenty comments displayed. According to the present invention, www.politico.com can arrange the comments such that the first five are reserved for free, default-format comments, and readers who leave free comments will see their comments cycle through the first five places in reverse chronological order, just as is currently practiced. But the remaining 15 comments on the page can be fee-paid comments that remain in position, i.e., order, according to the fee-payment scheme. In one embodiment the first paid comment can be comment number 20, and the next 19, and so on. In one embodiment, as each fee-paid comment is posted, the cost to the reader for the next fee-paid comment is increased, thereby letting market conditions set the price for distinctiveness, and inherently controlling the number of fee-paid distinctive comments, such that they might all remain on the first page. In one embodiment, instead of limiting the first page of comments to a set number n, such as n=20, the first page can be extended to hold all the fee-paid distinctive comments, regardless of the number.

In one embodiment the reader can bid for a desired spot, and if he or she is successful he or she can also put in a maximum bid to be automatically increased in predetermined increments if others bid for the same spot. Again, the basic concept is the same as, and can utilize all relevant software, executable programs, executable instructions, components, graphics, and algorithms of current online auction methods, such as the methods utilized by websites like eBay®. In this manner more than one reader can bid on any given desired position for posting a comment, with the criteria for successful posting simply being the highest bid. In one embodiment the internet content provider can set a predetermined time period in which bids are received, with the winning bid being rewarded the subject comment distinctiveness.

In one embodiment, the reader may desire to respond to another comment. In this case, the reader can be given the option of having the prior comment, to which he or she is responding, given the same distinctiveness of appearance and/or location as the reader's comment.

In one embodiment, another person other than the reader who left a comment can pay a fee in exchange for having a comment made by another rendered distinctive. For example, a reader reading the comments made by others may read a comment in a free default format, which the reader would like to highlight for others by paying a fee in exchange for distinctiveness. In this embodiment, the internet content provider can enable a way for each comment, including free, default format comments can be made distinctive. For example, after posting, each comment can have associated therewith a “button” or other location to “click on” which enables any reader to pay for distinctiveness of any comment.

In one embodiment, a commenter can be provided the means for ensuring that others cannot render their comment distinctive. For example, before leaving a comment to be posted in the comments section of a news story or blog entry, a commenter can be prompted to choose whether or not he or she would allow another person to change the appearance of the comment from the free default format to an altered distinctive format.

Therefore, the system and method of the present invention can be described as an internet-based system and method in which an internet content provider provides news or blog entry content on a website, for example, directly or via a server as is known in the art, or via any other manner known in the art. The internet content can be accessed by a person having an internet connection from a remote computer, such as a home computer connected via a service provider to the internet. For example, the internet content provider can be CNN.com, Foxnews.com, Yahoo.com, Salon.com, and the like, and the service provider can be Time Warner ROADRUNNER®, AOL, and the like. In general, the internet content provider and connected computer users utilize digital computer means to publish and access content via the internet, such as the World Wide Web, and can implement the content and other web-based activities by means of a processor for executing computer executable instructions and a memory for storing at least the computer executable instructions. The computers, processors, and memory can be any of known devices as is known in the art for implementing internet-based information content and user-configured online transactions.

In the present invention, in addition to permitting comments to be posted in a free default format, computer executable instructions of the system can prompt the reader to choose, such as by clicking or double clicking on a designated radio button, hyperlink, or other link, to pay a fee in exchange for the reader's comment, or comment chosen by a reader, being modified for distinctiveness relative to the free default format. The reader can be prompted at the time of making a comment, or the reader can be provided a link to elect to pay for distinctiveness of a previously posted comment.

Prior to paying a fee, or after electing to pay a fee, computer executable instructions of the system can provide one or more options for the reader or other user from which to choose. The internet content provider can provide one or more templates having pre-selected color and font schemes. The internet provider can provide an a la carte selection of various colors, borders, fonts, and the like so that the reader can choose his or her own attributes of distinctiveness. The internet content provider can provide a preview of the comment so that the reader can see what it will look like in the context of other comments before choosing to complete the transaction and have the altered, distinctive comment posted.

In one embodiment the fee required for a distinctive comment can be dynamically adjustable, and can be determined by conditions set by the internet content provider. For example, a base fee for a distinctive comment can be set to be a nominal cost of Y dollars. However, if many people are purchasing distinctiveness, it may be that “distinctive” is not so distinctive, so the internet content provider can raise the fee to Z>Y dollars, thereby letting market conditions moderate how many distinctive comments are in a particular thread of comments. For example, the fee can be governed by an algorithm programmed into the computer executable instructions that adjusts the fee based on the percentage of distinctive format comments relative to the total free default format comments in a particular thread. When the percentage reaches a set figure, the fee can be raised accordingly. Likewise, if the percentage lowers below a set figure, the fee can be lowered to attract more paid comments.

In an embodiment incorporating a dynamically adjustable fee, the comment distinctiveness can be an altered appearance relative to a free default format, but the comments can be otherwise posted in chronological order. The algorithm that governs the dynamically adjustable fee can take into account the number of consecutive distinctive comments, such that upon a set number, such as three, the fee can increase such that the distinctive comments do not become indistinct due to relatively close proximity to other distinct comments.

By having a dynamically adjustable fee, an internet content provider can generate increased revenue above that which a flat fee might generate. Particularly controversial news or blog entries, for example, can generate many heated and emotional responses, such that the value to a reader for posting a distinctive comment can be greater, and with more interest in being distinctive, the internet content provider can enjoy greater revenue with increasing fees for distinctive posts.

Once the reader chooses to pay a fee, or after a reader wins the bidding for an auctioned distinctiveness, computer executable instruction can facilitate that the fee be paid via any of known internet fee-payment methods, including by credit card transaction, debit card transaction, checking account transaction, and fee paying services such as PayPal®, as well as the method described herein below. The fee can be paid from a payment account of the reader, such as a credit card account, a debit card account, a checking account, or a PayPal® account. The fee can be received in a receiving account, which can be a bank account of the internet content provider, or a third party entrusted with handling the financial transaction for the internet content provider. The computer executable instruction can generate for the reader confirmation of fee payment on screen, or via an email receipt, and the on screen information can provide the commenter any other information deemed necessary by the internet content provider. The fee can be paid by the method and system disclosed more fully below, in which a reader need not remember a user name and/or password to complete the financial transaction for fee payment.

In one embodiment, a distinctive comment can be auctioned to a highest bidder. In one embodiment, computer executable instructions display to a reader an offer for particular distinctiveness, and receives bids from readers, who communicate their desire by responding to the onscreen instructions to do so. The computer executable instructions can set a time period in which multiple bids can be received, and the highest bid can win the auctioned distinctive comment once and for all. Or the computer executable instructions can place a highest bidder comment in predetermined place of particular distinctiveness only for the time before and until there is a higher bid for the same particular distinctiveness. For example, a news internet content provider can supply a news article to be displayed on an internet connected reader's computer operable to display the article, for example in a web browser. The news article can have at the end thereof displayed a comments section, and at least one position for one or more comments of particular distinctiveness reserved for a highest bidder. At Time 1, Reader 1 can bid N dollars and be the high bidder, thereby having his comment displayed with distinctiveness reserved for the high bidder. But, if at Time 2 Reader 2 bids and pays an amount greater than N dollars, then Reader 2's comment replaces Reader 1's or is placed in a position more distinctive than Reader 1's. In one embodiment, Reader 1 can then receive a notification, for example via email, that he is no longer the highest bidder, and provided an opportunity to bid again. In another embodiment, Reader 1 can set a maximum bid to be increased automatically in increments sufficient to outbid subsequent bidders, up to a maximum amount specified, thereby remaining in the distinctive position until the maximum bid amount is surpassed by another bidder.

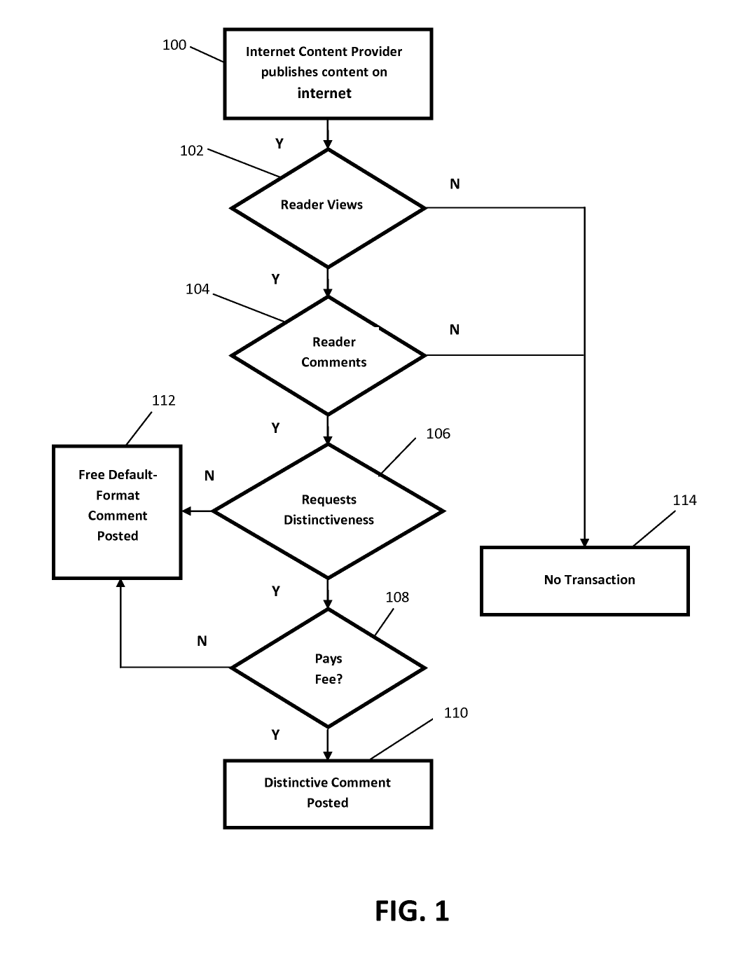

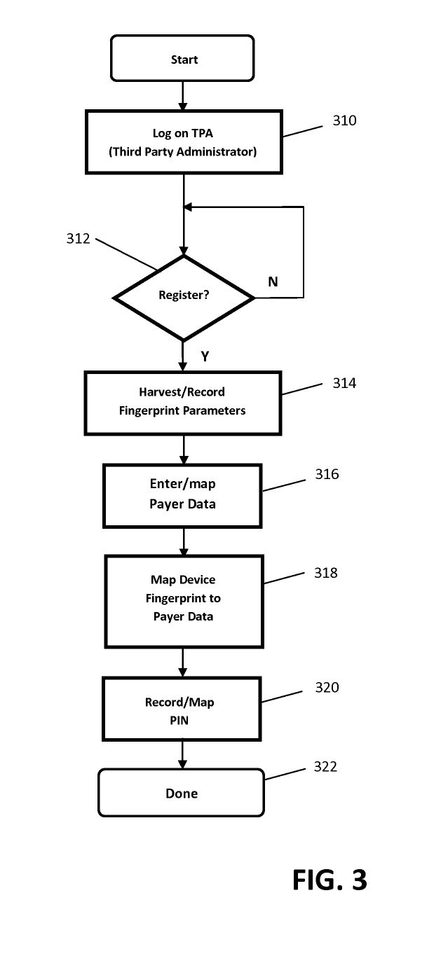

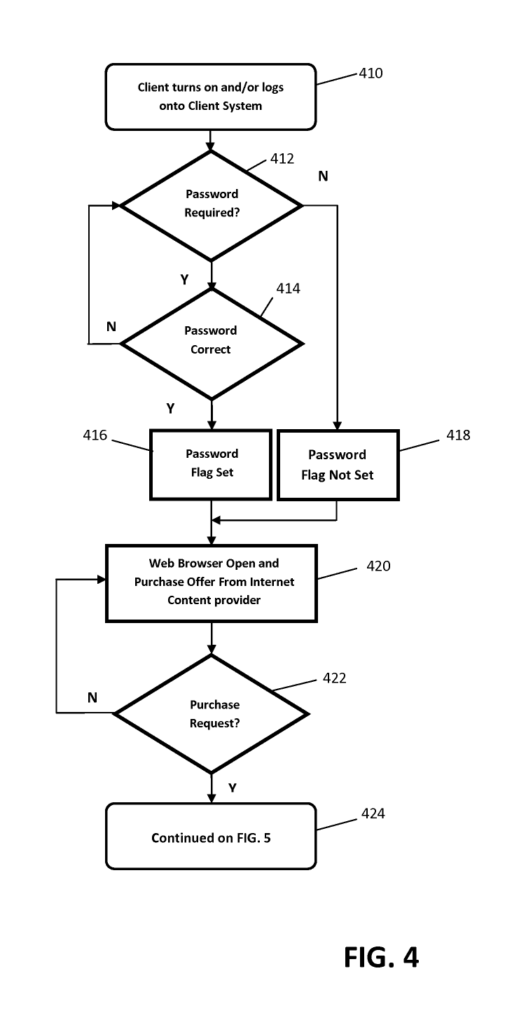

Referring to FIG. 1, one embodiment of a system and method for making money on the internet by providing for reader comment distinctiveness in exchange for a fee is shown. Generally, an internet content provider publishes content 100 on the internet, the content being accessible to readers by use of a computer having internet access and being connected via a web browser to the URL of the internet content provider. A reader views 102 the published internet content, which can be a news article, a blog entry, a video clip, and the like. The published internet content offers the reader the opportunity to leave comments, at least in a free default format or in a for-fee distinctive format. The distinctive format can be described by the internet content provider, including by examples of sample formats, positions, and the like. Leaving comments may require registration with the internet content provider, and may require approval by a moderator. The reader can choose to leave a comment 104, and decides whether to choose distinctiveness for his comment 106. If the reader does not view the internet content, or if the reader chooses not to leave a comment, there is no online transaction 114. If the reader chooses to pay for distinctiveness, the reader pays 108 via any known methods for executing a financial transaction over the internet, including by entry and processing from a reader's payment account, such as by use of a credit card or debit card, direct bank transfer, PayPal®, to the internet content provider's payment receiving account (or a third party's receiving account, as arranged by the internet content provider), or by the method and system described below with respect to the flowcharts shown in FIGS. 3 and 4. Once the reader's fee is processed, such that a payment is moved from a reader's payment account to the internet content provider's account, the reader's comment is posted in a distinctive format 110. If the reader does not wish to have her comment rendered distinctive, or if the reader does not pay a fee to do so, the reader's comment can be posted in the free default format 112.

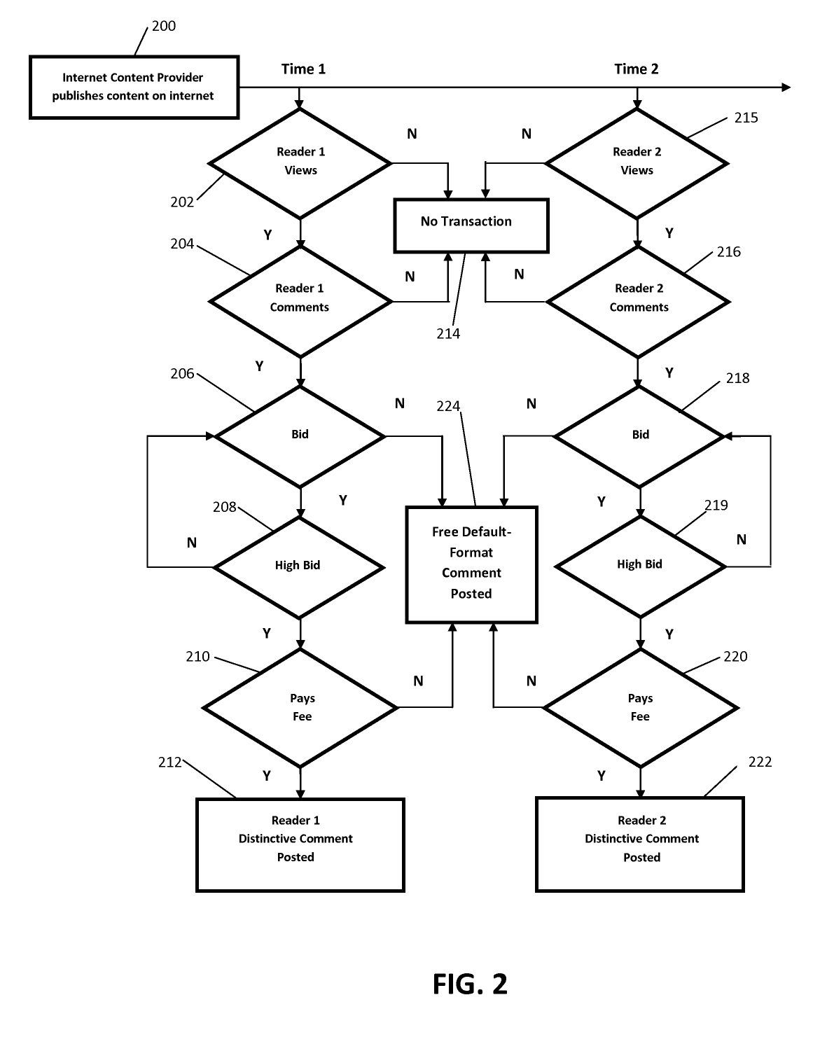

Referring to FIG. 2, one embodiment of a system and method for making money on the internet by providing for distinctiveness in exchange for a fee is shown. Generally, an internet content provider publishes content 200 on the internet, the content being accessible to readers by use of a computer having internet access and being connected via a web browser to the URL of the internet content provider. The published internet content offers readers the opportunity to post comments in at least in a free default format or readers can bid for a distinctive appearance and/or distinctive position of a posted comment. The distinctive appearance can be described by the internet content provider, including by examples of sample formats, positions, and the like. Leaving comments may require registration with the internet content provider, and may require approval by a moderator. At Time 1 a first reader, Reader 1, views 202 the published internet content, which can be a news article, a blog entry, a video clip, and the like. If Reader 1 chooses to not leave a comment, no transaction occurs 214. Reader 1 can choose to leave a comment 204, and decides whether to bid for distinctiveness for his comment 206. If the reader chooses to bid for distinctiveness, the reader bids 208 via known internet auction techniques, including those used by eBay®. If Reader 1 is not the highest bidder, Reader 1 can bid again 206. If Reader 1 is the highest bidder, Reader 1 can pay 210 the bid amount by any known methods for executing a financial transaction over the internet, including by entry and processing from Reader 1's payment account, such as by use of a credit card or debit card, direct bank transfer, PayPal®, to the internet content provider's payment receiving account (or a third party's receiving account, as arranged by the internet content provider), or by the method and system described below with respect to the flowcharts of FIGS. 3 and 4. Reader 1 can also, if provided for by the internet content provider, set a maximum bid and incremental amounts that he wishes the internet content provider to automatically raise his bid up to the maximum amount, in the event that a second reader wishes to out-bid Reader 1's current bid. Once Reader 1's fee is processed, such that a payment is made from Reader 1's payment account to the internet content provider's account, Reader 1's comment is posted in a distinctive format 212. If Reader 1 does not bid or does not pay the bid amount, Reader 1's comment can be posted in the free default format 224.

Further as shown in FIG. 2, a second reader, Reader 2 can read 215 the published content 200 at Time 2, and can choose to leave a comment 216, and decides whether to bid for distinctiveness for her comment 218, with this aspect of the invention requiring that Reader 2 must bid higher than at least Reader 1's winning bid 219, as well as, if used, Reader 1's stored maximum bid 220, which can be raised automatically in predetermined incremental amounts up to Reader 1's specified maximum. If Reader 2 chooses to not leave a comment, no transaction occurs 214. If Reader 2 bids but is not the highest bidder, Reader 2 can bid again 218. If Reader 2 is the highest bidder, Reader 2 can pay 220 the bid amount by any known methods for executing a financial transaction over the internet, including by entry and processing from Reader 2's payment account, such as by use of a credit card or debit card, direct bank transfer, or PayPal®, to the internet content provider's payment receiving account (or a third party's receiving account, as arranged by the internet content provider). Reader 2 can also, if provided for by the internet content provider, set a maximum bid and incremental amounts that she wishes the internet content provider to automatically raise her bid up to the maximum amount, in the event that a subsequent reader wishes to out-bid Reader 2's current bid. Once Reader 2's fee is processed, such that a payment is made from Reader 2's payment account to the internet content provider's account, Reader 2's comment is posted in a distinctive format 222, which can replace Reader 1's or displace Reader 1's to a different position. If Reader 2 does not bid or does not pay the bid amount, Reader 2's comment can be posted in the free default format 224.

In one embodiment of the method of the present invention, the method can be as described above with respect to FIG. 2, but modified in that the internet content provider can allow for multiple “top” spots, such that a second, or third highest bidder can gain a particularly distinctive comment.

The method of the present invention can be implemented in conjunction with a promotion of the internet content provider. For example, the internet content provider can have a sweepstakes promotion, whereby readers who pay for comments can be entered into a sweepstakes for an award, such as an award for a “super-distinctive” comment, which can be a comment made uniquely distinctive for a time.

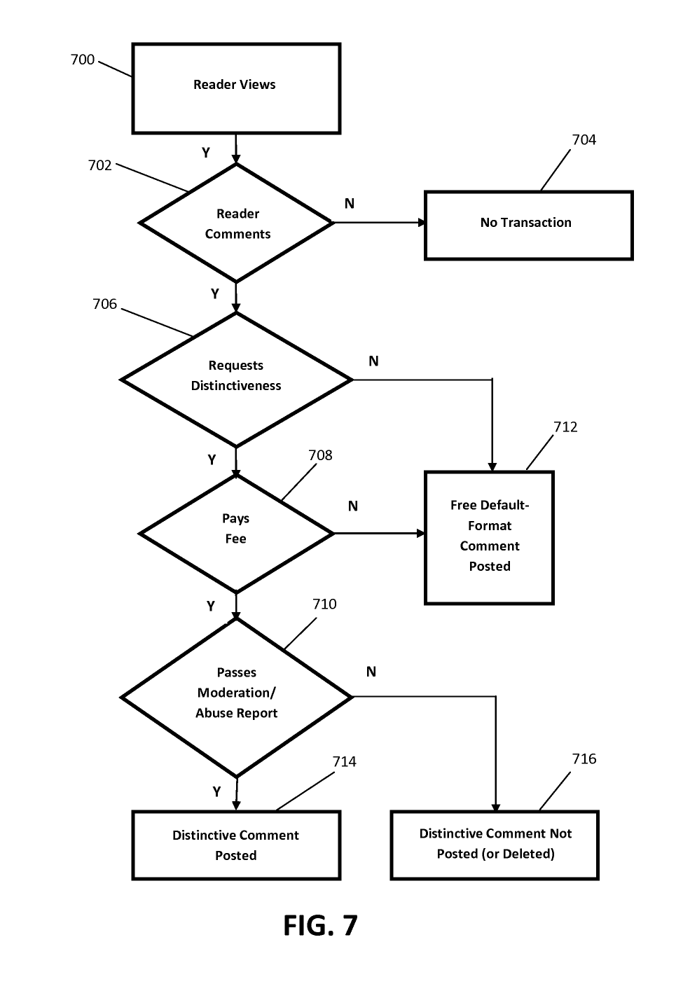

One foreseeable use of the system and method of the present invention which internet content providers may find objectionable is the use by readers to post comments which are in bad taste, vulgar, obscene, offensive, or otherwise unwanted on the internet content provider's website. Likewise, some readers may find fee-paid comments to be a cheap form of advertising, leaving comments for goods or services which the internet comment provider may find objectionable. For this reason, the system and method of the invention may utilize the steps shown in FIG. 7.

As shown in FIG. 7, a reader views internet content 700, and can choose to comment 702. If the reader does not comment, there is no transaction 704. If the reader does choose to comment, the reader can request distinctiveness 706 and pay a fee 708. If the reader does not request distinctiveness, or does not pay the requisite fee, the reader's comment can be posted in a free, default format. As shown in FIG. 7, after a reader pays a fee for distinctiveness, one of at least two methods can be utilized to check for appropriate content. First, the comment can undergo moderation. In one embodiment, a moderator, which can be a person in the employ of the internet content provider, or a functionally equivalent service provider, can read the comment first, and post only after the comment is deemed appropriate, the internet content provider can facilitate its posting in the fee-paid distinctive manner. In another embodiment, the fee-paid comment can have with it a “report abuse” feature, such as a button that readers can click to send a report to the internet content provider that a particular comment is inappropriate. The internet content provider can utilize a system, including a manual review by a person, or an automated system, by which user-reported comments can be reviewed and deleted. For example, the internet content provider can utilize computer executable instructions that recognize reports of abuse, and after a set number, such as 3, automatically deletes the subject comment until further review.

Further review can be instigated by the original commenter using an appeal procedure, as set by the internet content provider. Thus, as shown in FIG. 7, if a comment passes moderation, or survives abuse reports 710, it is posted (or remains posted) as a distinctive comment 714. Otherwise, the comment is not posted, or is deleted 716. In any event, upon not posting or deletion, the fee paid can be refunded, at least in part. But in one embodiment, the fee paid is not refunded. Such a non-refundable fee can deter would-be commenters wishing to abuse the system.

FIG. 8 shows a typical page on a website supported by servers of the internet content provider, and viewable on client computers, such as those of a reader viewing the website on a computer's web browser. The web page depicted in FIG. 8 is intended to represent either a news site such as www.cnn.com, or a blog site, such as www.politico.com. However, the type of website is not critical to the benefits of the present invention, and the news or blog site depicted is exemplary and not limiting. Typical news or blog sites have an area or “window” in which a news story or blog entry can be shown 802. Often a web page will have a section for advertising 804. Sometimes there is also a place for links to other news articles of interest 806. Of interest to the present invention, often below a news article or blog entry there is a place designated in which reader comments can be posted 808. Reader comments can be listed in chronological order, and are often posted in reverse chronological order with the first comment to appear, i.e., Comment No. 1 being the most recent comment to be posted. In such an arrangement, Comment No. 1 will become Comment No. 2 after another comment is posted. Usually only a certain number “n”, such as ten, comments are posted on the page with the end of the news story or blog entry, so that what starts as Comment No. 1 can become comment “n+1” and is no longer on the first page of comments. Often a reader's comment is quickly buried in hundreds of comments, likely never to be read by anyone. As shown in FIG. 8, in some embodiments readers are required to register before leaving a comment 810. Registration often includes providing an email address and a password.

As discussed above, in one embodiment of the present invention, a default format can be that comments can be posted in reverse chronological order, with the most recent being first. In FIG. 8, for example, in a default format Comment No. 1 812 would be the most recent comment posted, Comment No. 2 814 the next most recent, and Comment 3 816 the next most recent, etc. In such a system, the very first comment posted for a particular story becomes the last comment in line, constantly being pushed down the list as new comments are posted. In the present invention, however, it can be that Comment No. 2 was left more recently than Comment No. 1, but Comment No. 1 is a fee-paid comment, the fee being paid for the distinctiveness of being, and remaining, first. Once the fee is paid from the payer's account into the payee's account, the internet content provider can manually (i.e., by “cut and paste”), or by way of computer executable instructions, post the paid-for comment “out of order” and in the paid-for distinctive position. Therefore, instead of being pushed down the list with each new comment, Comment No. 1 remains number one by virtue of its paid-for distinctiveness. Of course, depending on how the internet content provider structures its comment payment system, Comment No. 1 can be displaced; for example, if the reader who left Comment No. 3 decides she wishes to be number one, she can pay a higher amount to displace Comment No. 1 for the first position, and Comment No. 1 could then become Comment No. 2.

As discussed above, and illustrated in more detail in FIG. 9, in one embodiment the internet content provider can have fee-paid comments posted in a separate “window” of the comments web page. In such an embodiment, on the subject web page 900, in addition to the area or “window” in which a news story or blog entry can be shown 902, and advertising 904, and other articles of interest 906, the comments can be divided between default format comments 904 and fee-paid comments 912. In this embodiment default format comments 908 can be posted in a default format such as chronological or reverse-chronological order. But fee-paid comments can be displayed in a separate window 912 in which the order and placement of comments follows from the particular plan set by the internet content provider. In such an embodiment, readers of the news or blog content can read both free default-format comments and fee-paid comments on the same web page 900.

A reader can be required to register with the internet content provider prior to posting a comment, and such registration can be facilitated by a separate area of the web page, such as 810 in FIG. 8 or 910 in FIG. 9, in which the reader can enter the requisite registration information, such as an email address and password. Whether or not registration is required or not, the reader can be directed to a web page 1000 similar in content to that shown in FIG. 10. On such a web page the reader can type in (or cut and paste, link, or otherwise enter) text or data into the field provided 1020. Entry of comments can be facilitated by any means commonly known in the art for doing so, including text editors and associated software.

After a reader enters text and/or data for the comment, he can preview his comment by clicking on a Preview button 1022, or he can post the comment by clicking on a Post Comment button 1024. If the reader wishes to post a comment in a free, default format, he can simply click on Post Comment, and the comment can be posted (with or without moderation). However, a reader can be prompted by suitable graphics 1026 to consider paying a fee to have his comment made distinctive. By clicking on the indicated link, such as graphics 1026 the reader can be presented with details of cost and benefits, including choices and alternatives with respect to distinctiveness, and provided with payment options. If the reader pays the requisite fee, the internet content provider can post the reader's comment in the paid-for distinctive format.

In one embodiment, as disclosed in more detail below with respect to “one-click” payment methods, the reader can be prompted to make her comment distinctive with a one click. As shown in FIG. 9, for example, a reader can click on a particular graphic 1028 such as one with a catchy phrase like “Bump It” and with that one click the reader's payment is facilitated and the comment is posted in a distinctive format.

Once a reader decides to leave a comment, the reader can be presented with a web page such as page 1300 shown in FIG. 13, in which the reader of news or blog content is provided the opportunity to pay a fee in exchange for the internet content provider posting the comment in a distinctive manner. Many variations of presentation of information can be implemented in accordance with the present invention, and the example of FIG. 13 is intended to be exemplary and not limiting. As shown, the reader can be given choices in a section 1302 to do one or both of paying for a distinctive position and/or paying for distinctive appearance. As shown in FIG. 13, the commenter can pay for each separately, such as paying for the first position and paying for a certain background color. Or, a commenter can pay for one or the other, for example, pay for a distinctive position, which can result in the comment being displayed distinctively in a paid-for position, but with a default text and background format. If the reader wishes only to have his comment made distinctive in appearance, but not in position, the reader can choose to “checkout” by clicking a suitable button, such as checkout button 1308.

As shown in FIG. 13, a certain position, such as first comment to appear after a news story or blog entry can be bid for. In one embodiment the information presented on page 1300 can indicate the current highest bid, so that the bidding reader knows how high he or she must bid to gain the desired position. In another embodiment, the reader can bid and receive confirmation of status, and then, if necessary, bid again. If the reader is the high bidder, the internet content provider can indicate this to the reader by a suitable message, such as that shown in window 1306. At this point, the reader can choose to pay and complete the transaction by clicking a suitable button such as checkout button 1308. At any time the reader can also choose to decline fee-paid distinctiveness, such as by clicking on a link like button 1304 and instruct the internet content provider to simply post the comment in the default format. Another option (not shown) can be an exit button, which a reader can click to simply end the entire transaction and not post any comment at all.

Once a reader decides to checkout, payment can be completed by any means known for online internet financial transactions. For example, the reader can be presented with a page for entry of suitable financial information, such as name, address, credit card information, billing address, and the like. In another embodiment the reader can pay by utilizing PayPal®, or functionally equivalent payment systems such as Amazon PayPhrase™, Google™ Checkout, or the like. In another embodiment, the reader can use one-click technology, represented in FIG. 13 by the Bump It! button 1310. One method of one-click payment is disclosed more fully below.

As discussed above, and discussed in more detail here, all of the systems and methods of the present invention are intended to be practiced in conjunction with known computers, servers, systems, and operating software. Referring now to FIG. 11, there is illustrated a block diagram of a computer operable to execute the disclosed architecture with respect to systems and methods of the present invention. In order to provide additional context for various aspects of the subject invention, FIG. 11 and the following discussion are intended to provide a brief, general description of a suitable computing environment 1100 in which the various aspects of the invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 11, the exemplary environment 1100 for implementing various aspects of the invention includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1394 interface technologies. Other external drive connection technologies are within contemplation of the subject invention.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is appreciated that the invention can be implemented with various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1394 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1102 is connected to the local network 1152 through a wired and/or wireless communication network interface or adapter 1156. The adapter 1156 may facilitate wired or wireless communication to the LAN 1152, which may also include a wireless access point disposed thereon for communicating with the wireless adapter 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth® wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Referring now to FIG. 12, there is illustrated a schematic block diagram of an exemplary computing environment 1200 in accordance with the mechanism(s) of the system and method of the present invention. The system 1200 includes one or more client(s) 1202. The client(s) 1202 can be hardware and/or software (e.g., threads, processes, computing devices). The client(s) 1202 can house cookie(s) and/or associated contextual information by employing the invention, for example.

The system 1200 also includes one or more server(s) 1204. The server(s) 1204 can also be hardware and/or software (e.g., threads, processes, computing devices). The servers 1204 can house threads to perform transformations by employing the invention, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

The method of the invention can be associated with a trademarked slogan, such as “Cop the Top Spot” and promoted conspicuously on the internet content providers web pages. In one embodiment an internet content provider displays in online information a window advertising an offer to make a comment distinctive.

The method of the present invention can be implemented by having “dueling comments” whereby two opposing viewpoints can be displayed in appropriately disposed comment sections, whereby two paying readers can have their respective viewpoints displayed for readers to compare. For example, two sections for fee-paid distinctive comments can be displayed in side-by-side relationship, or in alternating chronological relationship.

The method and system of the present invention can include as an added benefit the absence of a time and/or date associated with altered comments, that is, comments made distinctive by payment. Current blogs and news sites typically list the time and date of posting of comments. But, surprisingly, it has been found that such information adds nothing to the comment's value. Except for curiosity on the part of readers, the time and/or date is unnecessary and, although universally utilized, has no inherent value to the content of the comment. For this reason, in one embodiment of the present invention the altered comment lacks an indication of the time of posting. That is, a comment made distinctive according to the present invention can be posted in the absence of, i.e., without, an indication of the time of posting. Such lack of time and/or date notation can aid in avoiding a reader's prejudging a comment's content based on knowledge of payment, of suspicion of payment inferred by an out-of-order time notation.

The method of the present invention utilizes computers, wherein the term computers encompasses the whole of components such as processors, memory, servers, software, hardware, and the like, and wherein computers as such are machines for facilitating the method. Therefore, the method of the present invention can be described as machines transforming the subject matter of online reader comments. That is, the computer machines are utilized to transform the physical representation of the tangible expression of online comments, from one tangible output to a different tangible output, e.g., from a first default tangible expression of content to a second distinctive tangible expression of content.

The concept underlying the method of the present invention could be reapplied analogously to the print media of newspapers and magazines, with the system and method using online features and capabilities. A print magazine, such as Newsweek, could accept online submissions of letters to the editor for its newsstand print magazine, and could offer fee-based distinctiveness to readers who so desired. Readers who pay the associated fee could have their comments printed in the magazine made distinctive with respect to the free default comments.

The financial transaction involved with the payment of a fee by the reader, as well as a financial transaction for any exchange for any goods or services over the internet, can be completed according to the method and system described herein below. In particular, the method and system disclosed is intended to render the financial transaction virtually barrier free to the payer and payee alike. In the manner described financial transactions, particularly relatively low-value transactions, can be facilitated quickly and easily by the purchaser, resulting in increased revenue for the goods or services provider, typically referred to as online merchants.

As stated above, the term “payer” is a person, company, or other entity controlling a payment account from which monetary funds can be dispersed or otherwise debited for goods or services. That is, a payer is the person from whose payment account funds are transferred from in a financial transaction according to the method and system herein (referred to herein as payer or payer/client). However, because the method and system disclosed below can work solely on the basis of the identity of the client system (e.g., a home computer), and not the identity of the person using it at the time of a financial transaction, the term payer is also used herein to indicate one using a client system for purposes of effecting a financial transaction, even though it is recognized that in actual practice the person completing a financial transaction may not be an actual payer but can be a reader using the payer's client system, a commenter using the client system, a client system owner, as well as a fraudster, an identity thief, a hacker, a forger, or an otherwise unauthorized user of the client system.

In other words, the essence of an embodiment of the payment system of the present invention is a system in which a third party administrator (like PayPal in current, known methods) facilitates a financial transaction between a registered payer and a registered payee on the basis of recognition of the payer's registered client system alone. Anyone using the payer's client system can with one-click make a financial transaction without providing any further credentials such as a password, pay phrase, PIN, or username.

Without being bound by theory, it is believed that the method and system of the present invention for facilitating a relatively quick, easy electronic financial transaction is beneficial because users are willing to incur relatively more risk with respect to unauthorized transactions in exchange for ease and speed of the transaction and control over, and limits on, the consequences of any unauthorized purchases. In particular, for micropayments, for example payments for less than US$10.00, or less than US$5.00, or less than US$1.00, or less than US$0.50, users are likely to be willing to bear more risk, if penalty for mis-use is slight. Micropayments can even be in the range of a few pennies, and such amounts have been proposed to permit access by readers to news content, for example. As used herein, the term micropayment is used to denote payments of between US$10.00 and US$0.01 or less, and including all increments of 1/10 of one penny in between.

In one embodiment the method and system for payment of an amount for goods or services, including a fee for making a comment distinctive, can be paid from a payer's payment account into a receiving account for the benefit of the payee without the payer providing or needing to type in a password or any other user identifier at the time of the transaction.

In one embodiment the method and system for payment of an amount for goods or services, including a fee for making a comment distinctive, can be paid from a payer's payment account into a receiving account for the benefit of the payee without the need for manually entering credentials such as a password or other identifier as long as the purchase amount is below a payer-specified amount.

In one embodiment the method and system for payment of an amount for goods or services, including a fee for making a comment distinctive, can be paid from a payer's payment account into a receiving account for the benefit of the payee without the need for manually entering credentials such as a password or other identifier as long as the number of purchase transactions per time period, such as the number of purchases per day, is below a payer-specified number.

In one embodiment the method and system for payment of an amount for goods or services, including a fee for making a comment distinctive, can be paid from a payer's payment account into a receiving account for the benefit of the payee without the need for manually entering credentials such as a password or other identifier as long as the total cumulative purchase amount per time period, such as the total amount purchased per day, is below a payer-specified amount.

In one embodiment the method and system for payment of an amount for goods or services, including a fee for making a comment distinctive, can be paid from a payer's payment account into a receiving account for the benefit of the payee without the need for manually entering credentials such as a password or other identifier, but if a password has already been entered on the client system, such as in the user's initial log on, the already-entered password can be used as an additional credential for extra risk mitigation at the time of purchase.

In one embodiment the method and system for payment of an amount for goods or services, including a fee for making a comment distinctive, once a purchase amount is paid from a payer's payment account into a receiving account for the benefit of the payee, a message confirming the purchase can be sent to the payer, such as by email, cell phone, SMS text, Twitter, instant message or the like. In one embodiment confirmation is sent in a manner that is likely to be substantially instantly received by the payer, such as by instant message, text message, Twitter, or the like. In one embodiment, the confirmation is sent to a device other than the client system, such as to a payer's (or a payer-designate's) cell phone or other mobile device.

In one embodiment the method and system for payment of an amount for goods or services, including a fee for making a comment distinctive, once a purchase amount is paid from a payer's payment account into a receiving account for the benefit of the payee, and once a message confirming the purchase is sent to the payer, such as by email, cell phone, SMS text, Twitter, or the like, is sent, the payer can signal, such as by return email, SMS text, or the like, to refuse payment and/or to stop all future payments from the payer's account until further notification.

As mentioned above, the method and system for electronic payment by a payer of an amount to a payee as described herein is premised on the perceived fact that payers are willing to incur more risk for internet-based financial transactions in return for risk-mitigating control over unauthorized or mis-use of the method and system. For example, a payer desiring to make a purchase over an electronic network such as the internet is less likely to demand username and/or password access for purchase amounts that are relatively small, including so-called micropayments, which can be as low as pennies. Likewise, a payer desiring to make a purchase over an electronic network such as the internet is less likely to demand username and/or password access for certain transactions if the payer can be assured of receiving a timely notice of payment, including allegedly unauthorized payment, and, in some embodiments, provided the opportunity to stop any transactions, including future transactions in a timely manner.

For many financial transactions, such as payment for making a comment distinctive on an internet content provider's comment section, or downloading music, or contributing to charity, the amount to be paid can be relatively small, such as $1.99. For this relatively small amount, and due to the fast paced nature web browsing in general, many users would forego the payment and the benefit if payment required entering data, including a username and/or a password, because it's not worth the trouble. Likewise, for this relatively small amount, and due to an option wherein the user can pre-set user-specified risk-mitigating controls, such as a maximum amount per transaction, and/or a maximum number of transactions per time period (e.g., hour, day, week, etc.), and/or a maximum total amount per time period (e.g., hour, day, week, etc.), a user may be willing to forego the added security of a username and/or password for the convenience of a relatively quick, easy transaction.

In a system for electronic payment by a payer of an amount to a payee utilizing an electronic network such as the internet a payer first registers with a third party administrator (TPA) that retains payer-specific information and payee-specific information for use in facilitating financial transactions. Thus, a payer can register online with a TPA that records information in a manner known in the art for recording information, including confidential information, in an electronic format, including information such as the payer's name, address, mailing address, telephone number, wireless telephone number (for Twitter, voice and/or SMS text communication), credit card data, bank account data, personal identification number (PIN), security questions (for use in verifying identity), email address, twitter address and purchase limit criteria.

The purchase limit criteria can be used to place limits on per-transaction purchase amounts and/or the number of transactions per time.

In addition to the payer-specified information, the TPA can obtain a client system device fingerprint (also known as a machine fingerprint), which can be a representation of, and can be a summary of, certain software or hardware settings of the payer's client system computer, and which device fingerprint is intended to be unique to the payer's computer. A client system can be a home computer, a personal computer, a laptop, or any other electronic device capable of internet connectivity and communication of payment directives. A device fingerprint can be utilized by the TPA as a client system identifier, and a device fingerprint can be a unique identifier. The client system identifier is used by the TPA to authenticate the payer's client system and approve a request by a payer (or someone else using the payer's client system) for a financial transaction. The device fingerprint can be assigned to, or have components thereof assigned to, the client system by the server system of the TPA. The device fingerprint can consist entirely of non-assigned (by the TPA) data or information. The device fingerprint can consist of a string of binary units, a string of alpha-numeric characters, or combinations thereof. The device fingerprint can be passively assembled, without payer-noticeable querying of the client system, and can include factors such as a client system's TCP/IP configuration, OS fingerprint, IEEE 802.11 (wireless) settings, hardware clock skew, and combinations thereof. The device fingerprint can be actively assembled, such as by querying the payer/client for information, installing an executable code directly on the client machine, installing a “cookie” file, installing or recording attributes such as a MAC address, or other unique serial numbers assigned to the payer client system software or hardware. If necessary, the TPA server system can employ JavaScript or other client-side scripting language for the harvesting of parameters and/or the enabling of a device fingerprint, with the intention of establishing a stable, unique device fingerprint. The device fingerprint can be solely device specific, that is, the device fingerprint can consist solely of device-specific information or parameters and not any user-, or merchant server-specified information in the form of passwords, cookies, or the like. The device fingerprint can be solely, or substantially, a cookie. In one embodiment the device fingerprint comprises a cookie.

In one embodiment the device fingerprint is characterized by the absence of a cookie. In one embodiment, the device fingerprint comprises a cookie and at least one non-cookie component.

The device fingerprint can serve as the sole credentials for a TPA to authenticate a client system and to authorize payment from a payer's payment account. The TPA can, in some embodiments, be used with additional credentials, such as a password, a PIN, a voice command, a fingerprint scanner, a code on a cookie file, or other device. In one embodiment credentials other than the device fingerprint can be utilized for authorization by a payer for payments above the payer-set risk-mitigating limits discussed herein. For example, if a payer registers with a TPA and specifies that no purchase is to be authorized in amounts greater than $100, the TPA can authorize payments in amounts less than $100 based on obtaining a device fingerprint alone, but can authorize payments in amounts greater than $100 if the user of the client system enters additional credentials upon prompting by the TPA to do so. Likewise, the TPA can use additional credentials such as passwords and PINs to permit the payer to make changes to the payers TPA data.

In one embodiment, a device fingerprint can be a code, or a unique code, associated with and accessible from a client system hard drive or other component. For example, a hard drive manufacturer can embed in a segment of a hard drive, or record on another accessible component such as a graphics card, video driver, or the like, a code or other identifying device which can be accessible by other computer and/or server systems in communication with the client system, such as via the internet. In one embodiment, a device fingerprint can be a code, or a unique code, associated with software installed on a client system. In one embodiment client systems can be manufactured “TPA-ready” such that the hardware and/or software configuration(s) are set up for use with a TPA according to the method and system disclosed herein. In one embodiment, client systems can be “pre-registered” such as by being manufactured with a dedicated device fingerprint and wherein a user enters all necessary information onto the client system prior to accessing a TPA website. In such as system, the user can utilize the services of a TPA from the first time the user clicks a clickable access link from a registered internet content provider's website, without having to register on the TPA's website. The TPA can, upon first linking in by the client system, access, record, map, and otherwise store sufficient information to facilitate payment from a user's client system.

The device fingerprint can be obtained by the TPA upon a request by the payer for the TPA to authorize and pay an amount to a payee, and the access can be automatic and transparent to the payer, so that upon request for payment by the payer to the payee via the TPA, the TPA accesses the device fingerprint without the payer doing anything more. That is, the method and system of the invention can be implemented in a manner such that once a payer is registered with a TPA, the payer can make a purchase by clicking one link, or button, without being required to manually enter any information or data such as a password.

Because the TPA accesses the client system to detect a device fingerprint for authenticating a client system without further interaction from the payer, it can be that the device fingerprint is both unique (maximum diversity) to avoid another user inadvertently having the same device fingerprint, and unchanging (maximum stability), which can require that system settings not change on the client system. The two parameters can be linked in that the more relatively stable the device fingerprint (i.e., the less parameters used to build it, and therefore the fewer parameters subject to change), the more likely the device fingerprint may not be, or remain, unique relative to other client systems registered by the TPA. Therefore, in practice, if only client system parameters are used to compile the device fingerprint, it may be that the device fingerprint is not unique, and another client, different from the payer/client system, may have the same device fingerprint.

Because there is a possibility that the payer's client system's device fingerprint can be the same as another client system's, the method of the invention can include a step of a payer verifying his or her identity after the TPA recognizes multiple client system device fingerprints. Verification can be by any means known in the art, including by password, personal identification number (PIN), or merely by the TPA querying the payer for a first and/or last name, or by the TPA (for ease of user interaction) providing a payer-specific pick list of non-sensitive items, such as first names, including the names associated with both (or all) TPA-registered clients having the same device fingerprint, and having the payer indicate, such as by clicking on a button, his or her first name (or other payer-specific non-sensitive information). At this time computer executable instructions on the TPA servers and/or client-side scripting code can augment the client system device fingerprint to increase the chances of it being unique.

In one embodiment a single payer can be associated with (or “mapped” to in a TPA server database) more than one client device. For example, a single payer can register a home desktop computer, a mobile laptop computer, a handheld device such as a BlackBerry® or any other device capable of transmitting data over cable or wirelessly to a TPA server. The TPA can recognize a device fingerprint from any of the payer's devices, and facilitate payment from a payer's payment account to a payee's receiving account. In one embodiment the TPA can send a confirmation message of payment to a device that is not mapped to, or associated with, a registered device recognizable by a device fingerprint. In this manner, the payer, i.e., the entity controlling the payment account, can be notified of payment activity on a non-client system device for security purposes.

The payer can instruct certain transaction controls to the third party (i.e., the third party administrator, or TPA), such controls being implemented by computer executable instructions maintained by the TPA, and which are communicatively effective in facilitating a financial transaction between the payer and the internet content provider payee. The payer can instruct the TPA to use the payer's client system's device fingerprint for approving and implementing all purchase instructions. The payer can instruct the TPA to use the payer's client system's device fingerprint as a unique identifier for approving and implementing all purchase instructions for purchases below a maximum amount pre-set by the payer during registration, or later, with the TPA. The payer can instruct the TPA to use the payer's system log-on password and/or the fact of the payer having used a password to log onto the payer's computer (for example, by setting a “password flag” during startup) for purchases above an amount pre-set by the payer during registration with the TPA. The payer can instruct the TPA to limit the number of transaction per time, such as number of transactions per hour, or per day. The payer can instruct the TPA to limit the total amount of purchases per time, such as per hour, or per day. The payer can instruct the TPA to notify the payer upon each transaction, via email, SMS text, Twitter®, or any other form of communication. The notification of a transaction can include a way for the payer to stop future transactions, such as by a phone number, text message, reply text message, reply Twitter®, HTML hyperlink, or other electronic communication. All payer-specified controls can be set for use individually or in combination.

In one embodiment an internet user, such as a reader of news or blogs online, or a purchaser of online catalog content, registers with a third party administrator (TPA), the TPA then being accessible to internet content providers who can utilize its payment services, much like internet content providers currently can use PayPal® for facilitating financial transactions. Thus, just as a potential payer can register with PayPal®, and thereafter utilize the PayPal® button provided on by an internet content provider to facilitate an online financial transaction by entering at least a PayPal® password, the present invention contemplates a potential payer can register with a TPA any or all of at least the above-mentioned information (payer's name, address, credit card data, etc.) to be used according to payer-specified risk mitigating controls in an online purchase of goods or services without the requirement that the payer manually enter any information at the time of purchase. Thus, in one sense, the present invention can be practiced like a combination of PayPal® and the Amazon.com® 1-click® method. It is, in this sense, a “universal one-click” method in which online purchasers can use one click technology with any merchant utilizing the services of a TPA with which a payer/client is registered.

In one embodiment a system for payment by a payer of an amount to a payee utilizing an electronic network such as the internet can be implemented by an internet content provider utilizing the services of a TPA, and rendering the TPA services accessible to the payer. For example, just as PayPal® services can be provided for by showing at the point of purchase a PayPal® “button” for the user to click, the internet content provider can provide HTML hyperlink, radio button, or other “clickable” access to the TPA for selection by a payer. By way of example, the clickable access for one-click purchase is shown in FIG. 13 as button 1310, and can be, as shown in FIG. 13 designated by a trademark such as “Bump It!”.

In general, the TPA can facilitate a financial transaction according to any instructions agreeable to respective payers and payees. For example, in one embodiment, which can be implemented with any known payment system including PayPal®, Amazon™ PayPhrase, and Google™ Checkout, the fee paid to the TPA can be shifted or shared between the parties. For example, in one embodiment the payer can agree to pay the TPA's fee for services rendered in facilitating the financial transaction. In another embodiment, the payee can agree to pay such fees. In still another embodiment the fees can be shared.

In one embodiment, more than one trademark may be utilized to distinguish different modes of one-click purchase. For example, if the trademark “Snatch It” is used as a source identifier for a TPA's services utilized by an internet content provider, it can be used in modified forms. Thus, in one embodiment, if the internet content provider payee (which can be an online merchant) pays a fee, e.g., n % of the purchase amount, for the TPA service (similar to the current the practice for utilizing credit card services), the clickable button can be labeled “Snatch It Free”, as the service fee is “free” to the payer. In this sense, the service is like offering a toll-free telephone number to the payer. However, in another embodiment, the TPA registration information can facilitate that the payer pay the fee, e.g., n % added to the purchase amount, to the TPA, in which case, the clickable button can be labeled “Snatch It Fast”. In other words, variations on the payment protocol can be reflected in variations on the presentation of TPA service to the user.

In operation the electronic commerce system of the present invention utilizes a communication interface, such as the internet or other communication network, adapted to transmit financial transaction data, as is known in the art, and as is exemplified in FIG. 12. In one embodiment, in the terms of U.S. Pat. No. 5,960,411, which is hereby incorporated herein by reference for its enabling teaching of methods and systems for internet commerce, an internet content provider's server system and a client system, the client being in the context of the present invention a payer for online goods or services, and, in the context of a method and system of the present invention, can be a reader or commenter. The structure and methods of the present invention can be generally according to the description in the '411 patent with respect to FIG. 2 therein, which shows a client system in communication with a server system, with each system operatively connected via appropriate computer executable instructions to effect a financial transfer of funds from a payer to a payee. In the case of the '411 patent, the financial transfer is effected by so-called “one click” methodology between the client payer and the payee directly, without a TPA, using a methodology which relies on a server-assigned unique client identifier that is accessible to the server by way of a client file called a cookie. The present invention is an improvement over the “one click” technology embodied in the '411 patent.

In use, therefore, on a system of interconnected computers including client devices and internet content provider servers, the system can operate in the following manner. A third party server, i.e., the server system(s) of the TPA, can utilize computer executable instructions to receive, e.g., over an internet-based connection, information, which can be in the form of an inbound data packet, transmitted from a client device. The inbound data packet (or datagram, segment, block, cell or frame, depending on the protocol, as is known in the art) can be a result of a user of the client device clicking on a link on an internet content provider's website, just as currently a user can click on a PayPal® link, which sends a packet of data to the PayPal servers. Because the link was on an internet content provider's website, the internet content provider (i.e., an online merchant) is registered with the TPA (i.e., registration by an internet content provider with the TPA results in the internet content provider being granted permission to place an appropriate TPA purchase link. Such link can be provided in a “plug in” application provided by the TPA to the internet content provider), and the packet of data can include relevant information, including identification of the internet content provider, payment amount, and receiving account information, e.g., an online merchant payee's payment account. At this point the TPA server(s) queries the client device to determine if the client device is registered with the TPA. If so, the TPA server(s) recognizes the client device, e.g., via a device fingerprint, and queries a database in which a payer's payment account information is associated with the device fingerprint. The TPA server's executable instructions can then facilitate an electronic payment from the payer's payment account to the payee's receiving account. If the client device is not recognized, e.g., a payer associated with the client device is not registered, the TPA server's executable instructions can send an appropriate message to the client device, including an offer to register with the TPA. If a payer then registers with the TPA, the TPA's server's executable instructions can then facilitate electronic payment of a payment amount from the payment account of the payer to a receiving account of a payee.

The method and system of the invention can use data packet transmission technology as is known in the art, and as disclosed in any or all of U.S. Pat. No. 4,947,028, entitled Automated Order and Payment System; U.S. Pat. No. 5,920,847, entitled Electronic Bill Pay System; U.S. Pat. No. 5,956,699, entitled System for Secured Credit Card Transactions on the Internet; U.S. Pat. No. 4,771,458, entitled Secure Data Packet Transmission System and Method; U.S. Pat. No. 5,293,379, entitled Packet-based Data Compression Method; U.S. Pat. No. 5,623,605, entitled Methods and Systems for Interprocess Communication and Inter-Network Data, each of which are hereby incorporated herein by reference for all enabling teaching of data packet protocols and technology, particularly as related to payment systems using the internet.

The method and system of the invention can use network security and fraud detection systems and methods as disclosed in U.S. Pat. No. 7,272,728 and U.S. 2005/0278542, each entitled Network Security and Fraud Detection System and Method, and each of which are hereby incorporated herein by reference for all enabling teaching of network security and fraud detection, as well as for network device registration, reputation monitoring, uniquely identifying client devices, and generating fingerprints for network devices, such as the payer client systems of the present invention.

The method and system of the invention can make use of any known online payment methods and systems, including those disclosed in U.S. Pat. No. 5,677,955, entitled Electronic Funds Transfer Instruments; U.S. Pat. No. 7,275,685, entitled Method for Electronic Payment; and, U.S. Pub. No. 2007/0170245A1, entitled Secure Payment System, each of which are hereby incorporated herein by reference for all enabling teaching of online payment systems and methods, secure payment systems and methods, components, software, hardware, interface devices, and the like.

A method and system of the present invention for fast, easy, risk-mitigated electronic commerce is described with respect to the flowcharts depicted in FIGS. 3-6. In the illustrated embodiment certain non-limiting options and features are described. The skilled person will recognize that some or all of the disclosed features can be utilized in a method of the present invention, and the illustrated embodiments are not to be construed as preferred, optimal, necessary, or otherwise limiting. It is understood that all features and advantages of the present invention can be utilized or augmented with known technologies for security, such as encryption methodologies; speed, such as dynamic directory services; or any and all computer hardware, software, firmware and supporting accessories. Such methodologies can be according to the teachings of U.S. Pat. Nos. 7,209,970, entitled Authentication, Application-Authorization, and User Profiling Using Dynamic Directory Services, or 6,957,334, entitled Method and System for Secure Guaranteed Transactions over a Computer Network, or 6,330,550, entitled Cross-Media Notifications for E-Commerce, each of which are hereby incorporated by reference herein for their respective enabling teaching of methods and systems for electronic commerce, all of which teaching can be utilized in the present invention.

The method and system of the present invention generally involves three entities (or parties): 1) a payer (or first party), who can also be the reader of internet content who wishes to pay to have his comment made distinctive or purchase goods or services online; 2) a payee (or second party), who can be the internet content provider or other online merchant, and who is ultimately the recipient of the funds from a payer's account; and 3) a third party administrator (TPA) (or third party), which authenticates a payer and administers payment from a payer to a payee.

The TPA is a party that acts as the “go-between” transaction facilitator between a payer/purchaser on a client system and a payee/merchant on a server system. Thus, a TPA of the present invention serves a similar function as that served by PayPal® in known methods and systems of electronic commerce, and a TPA can use any and all useful features and components of a PayPal® or PayPal®-like system as can be beneficially utilized in conjunction with the present invention.

A payer who desires to take advantage of the features of a method and system for electronic commerce described herein first registers from the payer/client's system with the third party administrator. Registration can involve supplying certain information relevant to identifying a client system, a payer, and a payment account, and can be achieved in any known manner, including by telephone, U.S. mail, or electronically by logging onto the TPA's website 310, for example by entering the TPA's URL into the client system's web browsing software. Registration can involve, for example, filling in fields on an online form which the TPA uses to populate a mapped directory of information which the TPA then stores and uses for facilitating monetary transfers. The payer can choose to register with the TPA 312, thereby availing the payer of the TPA's services. If the payer chooses not to register, the payer can stay on the TPA's website at the registration page, or, of course, close the page.

In the registration process the TPA can gather certain information from the payer, by obtaining it directly from the payer's client system, such as passively harvesting parameter(s) for the device fingerprint, and/or by requiring the payer to enter certain information, such as credit card information. In one embodiment, the TPA obtains and records in a data file the device fingerprint parameters 314 of the registering payer. The device fingerprint can serve in later transactions as a unique identifier of the payer's client system, and can serve as the sole credential for the TPA to authenticate a client system and authorize payment from a payer's payment account.

TPA computer executable instructions can facilitate at registration obtaining other payer information and mapping the information to the payer's client system's device fingerprint 316. Payer information can include any or all of various information such as the payer's name, address, mailing address, telephone number (for voice and/or text communication), credit card data, bank account data, security questions (for use in verifying identity), email address, PIN number (for use in verifying identity, or for approving over-limit transactions, twitter address and purchase limit criteria. The purchase limit criteria can be used to place limits on per-transaction purchase amounts and/or the number of transactions per time, and/or the total purchase amount over time. The TPA can also utilize, or embed, a file on the payer's client system to set a flag, referred to as a “password flag”, if the payer utilized a password to log onto the payer's client system prior to logging onto the TPA's website. Many of the payer-specified information, such as a PIN, as well as certain parameters such as the password flag, can be utilized as extra risk-mitigating credentials or controls by the TPA.

Computer-executable instructions on the TPA system can facilitate the various methods and processes of the present invention, including mapping the entered payer data 316 appropriately in any manner known in the art, as well as any other payer-specified or system-provided controls the TPA offers. For example, the TPA can offer the option, and the payer/client can choose, to specify a maximum purchase amount per transaction, placing an upper limit on how much any individual purchase amount can be. Likewise, a payer/client can specify a maximum number of purchases per period of time, such as a maximum number of purchases per 24 hours, placing an upper limit on the number of purchases that the TPA can approve in any given time period, such as per hour, day, week, and the like. Further, a payer/client can specify a maximum total purchase amount per specified time period, placing an upper limit on the total purchase amount the TPA is to approve for any given time period, such as per hour, day, week, and the like. Still further, the payer/client can provide, and the TPA can record/map, a password or PIN to permit the payer/client to exceed the payer-specified limits, if desired.

The payer-specified controls can be utilized by the payer to mitigate risk associated with unauthorized use of the payer's client system by others. Thus, if the payer's client system's device fingerprint is utilized by the TPA to authenticate the payer and approve payment from the payer's mapped credit card account, an unauthorized user of the payer's client system (e.g., the payer's computer from which he registered with the TPA), can make unauthorized purchases, but the amount and/or number of such purchases will be constrained by the risk-mitigating limits imposed by the payer during registration and account set up. These limits can effectively shield the payer from excessive losses due to unauthorized use. Moreover, as disclosed further below, after each purchase, the TPA can notify the payer via, for example, text message to the payer's cell phone upon completion of any purchase (or start of any transaction process), and the payer can, if desired, instruct the TPA to stop all transactions until further notification by the payer. Likewise, if, by chance, another client system has a device fingerprint identical to the payer's client system, the TPA can ask for further authentication from the payer, such as requiring the payer to enter a PIN, or answer a security question, or the like.

In one embodiment, all the payer-specified controls to limit risk of unauthorized use can be payer client system log-on password dependent. That is, upon linking to the TPA for a purchase transaction, the TPA can query the payer/client's system to indicate if, upon start-up of the payer's session on the payer's client system, the payer entered a password. If so, a password flag is set. Alternatively, a payer/client system's computer can set a flag upon entry of a correct password, and the TPA server system simply recognizes on the client system the status of the password set flag. The payer can specify a different upper limit to all purchase limits based on whether the password flag is set or not. For example, the payer/client can specify a maximum purchase amount per transaction of $5.00 if the password flag is not set, and a maximum purchase amount per transaction of $50.00 if the password flag is set.

TPA computer-executable instructions can map a payer's client system's device fingerprint to other payer information, such as the payer's credit card information 318. In like manner, any of the other information gathered during the registration process by the TPA can be mapped to the payer in a data file kept on the TPA server system, or otherwise recorded, kept or accessed as is known in the art. In one embodiment, the payer's device fingerprint can be a unique identifier assigned to the payer/client system, as disclosed in the above-mentioned U.S. Pat. No. 5,960,411. That is, the device fingerprint can be a cookie left on the client computer device which is retrievable by the TPA upon access to the TPA by the client device. One beneficial feature distinguishing the present invention from the '411 patent in the embodiment wherein the device fingerprint is solely a cookie, is the ability of the payer to set risk mitigating payer-specified controls, such as limits on amounts spent per transaction, or per time. One advantage of the present invention is the use for commercial transactions of the payer/client system's device fingerprint as a, or part of a, unique identifier. In such a system the merchant can utilize the TPA, obviating the need to assign a unique identifier to every user, and the payer need not remember a password, and need not be burdened with the time-consuming step of either entering a password, or going through a password recovery process.

Much of the information utilized by a TPA can be personally identifiably information (PII), and for that reason the TPA can have in place controls to ensure that PII is not inadvertently publicly disclosed. A device fingerprint can include PII, and, if so, can be maintained on the TPA's computer systems in a confidentially secure manner, as is known in the art for computerized systems holding confidential information.

The TPA can suggest or require a payer registrant to enter information for security purposes, such as a PIN 320, or other information like security questions. Such information can be utilized by the TPA to authenticate a payer if required for any reason, such as to make changes to payer information. Likewise, a PIN or other password or security question can be used by the TPA to authenticate and approve purchases that exceed any of the payer-specified controls, such as maximum amount per purchase.

A merchant/payee internet content provider can also register with the TPA information for achieving a transfer of funds from the payer's payment account to the payee's receiving account, including sufficient information to enable the TPA to facilitate the receiving of a deposit of monetary funds in a receiving account. Therefore, a potential payee internet content provider, such as an online merchant, desiring to have payers purchasing goods and services can register with the TPA such information as name, address, bank account number, bank codes, and the like. Upon registering, the merchant/payee can display upon the merchant's website(s) a visual indication of access to the TPA service, which indication can be a “clickable” hyperlink or a “button” for clicking on by the payer, in similar manner as currently many merchant websites make available by display the PayPal® service with a PayPal® button to be clicked on by the user. Clicking can be by known means, for example by pressing the left button of a mouse, or the left button of a laptop touchpad. The TPA service can be named a distinctive name that connotes ease and speed. Such names as TapIt™ or FlashClick™ or OneTouch™ or WhizIt™ or NanoClick™ or SnatchIt™ or BumpIt™ are contemplated as source identifiers for a TPA service.

A payer using a client system registered with a TPA can practice a method and system of the invention according to an illustrated embodiment as described in the flowchart of FIGS. 4-6. As shown in FIG. 4, a payer/client turns on or otherwise logs on his or her client system, such as a home computer, a laptop, or other computing device, including mobile devices. If necessary or desired, the payer/client uses a log on password to access and log onto the client system 410. Examples of such passwords are passwords to run Microsoft® Windows® software, passwords to run Novell® software, and the like. If a password is required, the client system can prompt for a password 412, and if the password entered is correct 414, a password flag can be set on the client system 416. If a password is not required a password flag is not set on the client system 418.

The payer/client can use a web browser such as Microsoft Explorer® to access websites on the internet, including merchant websites on which goods and/or services are offered for sale 420. An online merchant internet content provider can display as part of its online information an offer for sale of goods or services, and an offer amount. The offer amount can be a fixed amount, or can be a dynamic amount, such as in an auction context. The online merchant internet content provider can provide a clickable link for a payer/client, or other reader, to click on, the link being a button, radio button, HTML hyperlink, or other of any known clickable graphic devices which a payer desiring to accept the online offer can click. “Clickable” is used in its ordinary, contemporary meaning as is well known to users of internet content, and refers to a type of device, such as a graphical user interface device, displayed on a client system screen, and which a payer or reader can click on by one or more clicks of a mouse, pointing device, touchpad, or the like. Thus, a user can single click, double click, left click, right click, or tap a touch pad, or the like to click a clickable link provided for the purpose of initiating a purchase transaction. If touch screen technology is utilized, “clickable” can also refer to “touchable” “buttons” on the screen.

The payer/client can request to make a purchase by indicating such desire in any known manner, such as by clicking on a clickable link, such as a “buy it now” button, or an “add to cart” button, or the like 422. Clicking on the clickable link can link to the TPA, sending to the TPA by known methods relevant information such as the internet content provider's identity and the offer amount (or purchase amount). at which time computer executable instructions

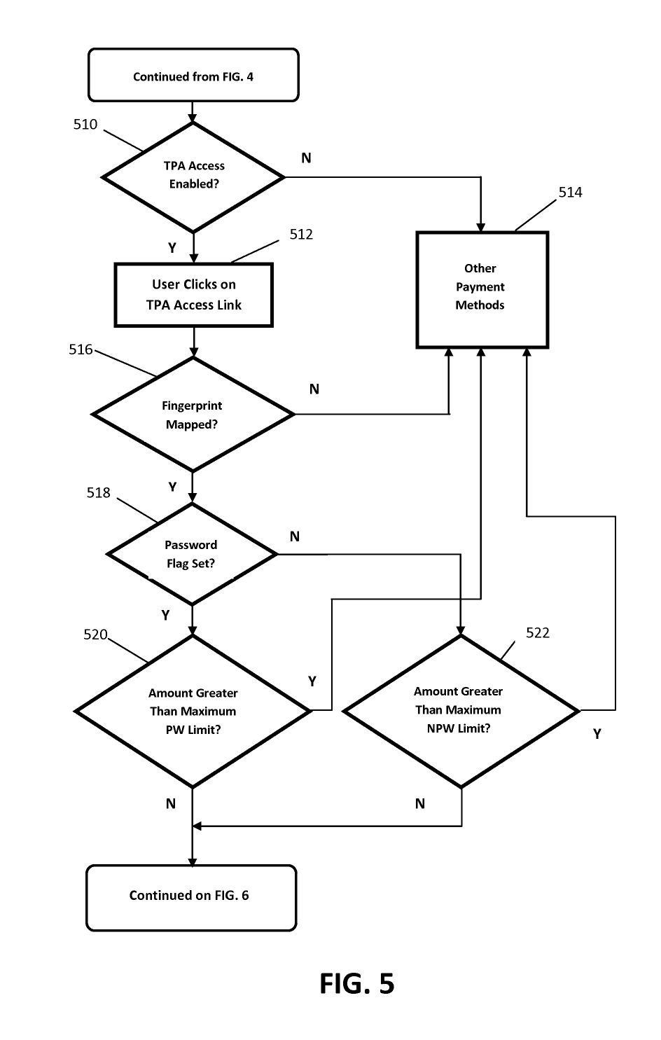

As further shown in FIG. 5, when a payer/client is ready to complete a purchase, if the merchant/payee has enabled TPA access such that a TPA service is enabled 510 and there is a clickable link provided, a purchaser for goods or services can click on a TPA access link 512. To the payer, clicking on the TPA access link is akin to clicking on Amazon.com's “Buy now with 1-click®” button in the sense that the remainder of the method and system can be largely, if not completely, transparent to the payer, and no further action may be required to complete the purchase of goods or services. Specifically, upon successful recognition by the TPA of the client system's device fingerprint, and if used, all other controls are satisfied, no other credentials are required from the payer/client at the time of purchase. That is, no more credentials such as passwords, PINS, unique codes, or other security devices need be utilized. In this manner, relatively easy and fast transactions can take place from any enabled internet content provider's online information, thus providing for a universal one-click feature on the internet. If TPA access is not enabled, the payer/client can complete a financial transaction using other payment methods 514, such as PayPal® or ordinary checkout with credit card data entry.

Once the TPA-registered payer/client clicks on the merchant's TPA access button, the client system communicates with the TPA system in a handshake in which the TPA identifies the client system device fingerprint and associates it with mapped payer data. For example, the TPA can recognize the client system by its device fingerprint and correlate the mapped payment account associated with the client system. If the device fingerprint is not mapped the payer/client can complete a financial transaction using other payment methods 514, such as PayPal® or ordinary checkout with credit card data entry. If the client system device fingerprint is mapped 516, the TPA can check if the client system password flag is set 518.

In one embodiment, the password set flag can be used as a control on purchasing options, such as a control on the maximum amount per purchase, or other limiting control, as set by the payer/client during registration and setup with the TPA. If used, for example, the TPA can query the password flag set and if the password flag is set check to see if the purchase amount attempting to be approved is greater than the limit for a correct password at client system start up 520, and, if the password flag is not set, check to see if the purchase amount attempting to be approved is greater than the limit for no password entered at client system start up 522. In other words, a password entry upon client system startup can serve as an additional control to mitigate risk of unauthorized purchases being made on a payer's client system.

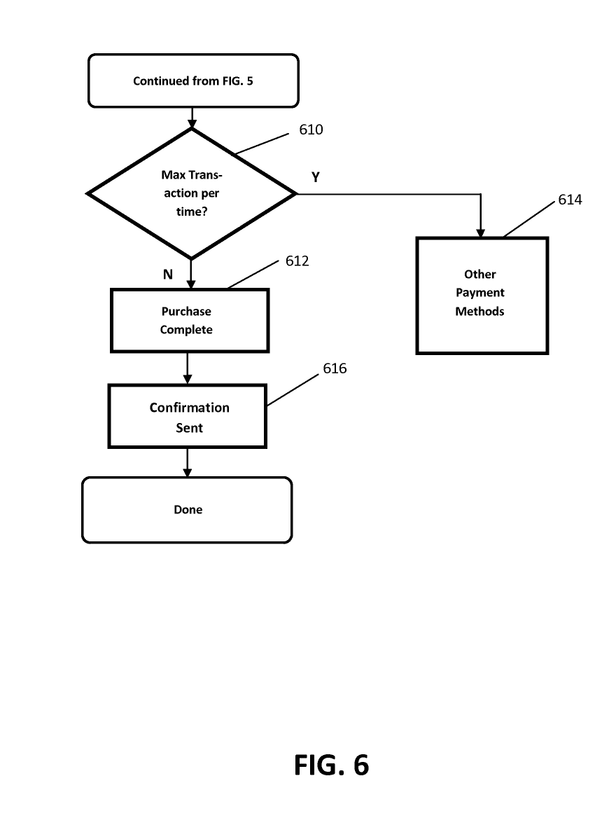

As shown in FIG. 6, the method and system of the invention can include a step of ensuring that the attempted purchase does not result in a cumulative amount per a set time period that exceeds a payer-specified maximum limit for purchases in the set time period 610. For example, the payer/client can, upon registration with a TPA, specify that the TPA not facilitate purchase amounts that total cumulatively greater than $50.00 per any 24 hour period. If the payment amount exceeds such a payer-specified limit, the payer/client can complete a financial transaction using other payment methods 614, which can be the same methods as previously indicated in FIG. 5 as 514, such as PayPal® or ordinary checkout with credit card data entry.

Once all controls have been satisfied, the TPA can facilitate by known means of electronic funds transfer completion of the purchase transaction 612. The payer's payment account as registered with the TPA can be debited such that funds can be withdrawn from the payer's payment account and deposited into the payees receiving account as registered with the TPA.

The amount of monetary funds debited and deposited can be at least the offer amount, and can include taxes or fees. In one embodiment, the offer amount can be debited from a payer's payment account, and an amount less than the offer amount can be credited to, or deposited in, an internet content provider's receiving account, with the difference representing fee(s) charged by the TPA, and/or credit agencies.

As an additional risk mitigating control, the TPA can send a confirmation of the transaction to the payer's communication device of choice 616. For example, the TPA can confirm transaction completion with an email to a payer's email account. Likewise, the TPA can send a Twitter® message to either the payer's client system or to a payer's cell phone. Likewise, the TPA can send a confirmation message as a text message to a payer's cell phone. In this manner, any use, including unauthorized use, of the payer's client system can be detected and the payer can act accordingly. In particular, if unauthorized use is made of a payer's client system the payer can receive notification even if he or she does not have immediate access to the client system.

In one embodiment, the method and system of the invention can include a feature in which a payer can easily and quickly stop further activity on his or her client system. For example, if an unauthorized use of the payer's client system occurs, the TPA can send a text message of purchase completion to the payer's cell phone, and the text message can contain a phone number, a link, a reply address, or the like, for which the payer can easily call, link or reply to instruct the TPA to stop all further transactions until notified.

Other variations and modifications can be included in the method and system of the present invention. For example, for added security, and in the event that two client systems registered with the TPA have identical device fingerprints, an additional confirmation step can occur after the TPA checks if a client system's device fingerprint is matched, i.e., at 516 of FIG. 5. In such an event, computer executable instructions from the TPA server can query the user of the client system for a password, PIN, or other identifier and receive back a correct entry before continuing with the purchase transaction.

Another embodiment of the invention can include opportunity for further monetization of internet activity by providing a reverse payment scheme in which an internet content provider can utilize the services of a TPA to transfer funds into the account of a payer. In one embodiment, the internet content provider can transfer funds to a payer upon a payer-initiated site visit from a contact of the payer. For example, after a payer completes a transaction to have a comment rendered distinctive, the payer can be prompted to send, and send, to friends or contacts, such as by email or Twitter® a message encouraging the friend or contact to visit the internet content provider's website. In one embodiment, the payer, after paying for a comment to be made distinctive, can choose to activate a send feature from the internet content provider's website, to send messages to contacts with a message like “Hey, I just left a comment; check it out!” or “You won't believe what people are saying here!” with a hyperlink to the internet content provider's website. Upon each visit by a contact of the payer, which can be authenticated by means known in the art, such as providing an appropriate URL or an embedded code, the internet content provider can authorize, via the TPA, for funds to be deposited in the payer's account.

In one embodiment, a payer, after paying for goods or services, or after paying for a comment to be made distinctive, can be prompted with the choice, such as by a clickable button and appropriate questions, to send a message to friends, family, or other contacts, encouraging them to visit the online merchant from whom a purchase was made. The message, which can be sent by any electronic means such as by email or SMS text, can be payer-generated or provided by the online merchant. The message includes an HTML hyperlink to the online merchant or internet content provider which is unique to the payer and recognized by the internet content provider as being provided by the payer. The unique URL can go to a landing page on the internet content provider's website, which landing page can be automatically re-directed to the page of choice, such as a news/comment page referred to by the payer in his message to contacts. In this manner, the internet content provider recognizes the URL as having been assigned to the payer, and can initiate a transfer of funds to the payer's account.

In another embodiment an internet content provider can provide no opportunity for free comments, but only paid comments. In such a system, the method of the present invention can be modified such that distinctiveness or position is determined by the amount paid relative to other commenter's amounts. Thus, as each commenter must pay to have his or her comment posted, those who pay more can have their comments posted nearer the top of the list, or with more distinctive visual features. In such an embodiment, rather than providing a “free” default format, the internet content can provide a “non-free” or “paid” default format. In one embodiment the internet content provider can require a base, or minimum, fee for posting in a default format, such as chronological order, and any payment over and above the base fee is considered the payment for distinctiveness, as disclosed herein.

While the invention has been described in detail, many other of various known features and methods, equipment, components, and techniques of online, internet-based systems and methods could be utilized with the present invention, such as reverse auction techniques, bid pooling, participant information gathering, use of virtual private networks (as distinct from a public internet), “one click” and “buy it now” features, dynamic and/or streaming pricing information, multiple participant transactional systems, secure information and data transmission, evolving dialog boxes, monitoring and notification of irregular network activity, prioritization of third party access to online sites, incentivizing comment reviews, and secure credit payment, to name some non-limiting examples. Therefore, the following patents and/or applications are hereby incorporated by reference herein, together with the above-mentioned U.S. Ser. No. 11/197,067, for their enabling teaching on various aspects and features of internet-based systems and methods, including those which could be incorporated to enhance the system and method of the present invention, but which for conciseness are not literally reproduced in full herein: U.S. Ser. No. 10/988,274, filed Nov. 11, 2004, entitled System and Method for Blog Functionality; U.S. Ser. No. 11/540,716, filed Oct. 2, 2006, entitled Method and Apparatus for Publishing Content Through Blog; U.S. Ser. No. 10/879,528, filed Jun. 30, 2004, entitled Content Publishing Over Mobile Networks; U.S. Ser. No. 11/443,436, filed May 30, 2006, entitled Providing Rewards for Manual User Insertion of One or More Ads into a Document to be Made Available to Another User or Users, for Distribution of Such Documents, and/or For User Actions on Such Distributed Ads; U.S. Ser. No. 11/420,970, filed May 30, 2006, entitled User Distributed Search Results; U.S. Ser. No. 11/464,813, filed Aug. 15, 2006, entitled System and Method for Conducting an Electronic Message Forum; U.S. Ser. No. 11/351,257, filed Feb. 9, 2006, entitled Facilitation of Online Discussion; U.S. Ser. No. 11/846,183, filed Aug. 28, 2007, entitled System and Method for Enhanced Interaction; U.S. Ser. No. 11/925,964, filed Oct. 28, 2007, entitled Methods for Publishing Web Content; U.S. Ser. No. 11/604,949, filed Nov. 27, 2006, entitled System and Method for Peer-to-Peer Internet Communication; U.S. Ser. No. 10/988,274, filed Nov. 11, 2004, entitled System and Method for Blog Functionality; U.S. Ser. No. 11/086,501, filed Mar. 21, 2005, entitled System and Method for Notifying of the Posting of a Web Logging Message Via a Dispatch Communication; U.S. Pat. No. 6,202,051, filed Feb. 19, 1999, entitled Facilitating Internet Commerce Through Internetworked Auctions; U.S. Pat. No. 6,449,601, filed Dec. 30, 1998, entitled Distributed Live Auction; U.S. Pat. No. 7,024,376, filed Jun. 30, 2000, entitled Internet-based Auction Method; U.S. Pat. No. 6,665,649, filed Mar. 10, 2000, entitled Smooth End of Auction on the Internet; U.S. Pat. No. 6,044,363, filed Sep. 2, 1997, entitled Automatic Auction Method; U.S. Pat. No. 6,466,917, filed Mar. 9, 2000, entitled Method and Apparatus for Verifying the Identity of a Participant Within an On-line Auction Environment; U.S. Pat. No. 5,890,138, filed Mar. 30, 1999, entitled Computer Auction System; U.S. Pat. No. 5,835,896, filed Nov. 10, 1998, entitled Method and System for Processing and Transmitting Electronic Auction Information; U.S. Pat. No. 6,044,363, filed Mar. 28, 2000, Automatic Auction Method; U.S. Pat. No. 6,269,343, filed Jul. 31, 2001, entitled Online Marketing System and Method; U.S. Pat. No. 6,415,270, filed Jul. 2, 2002, entitled Interactive Remote Auction Bidding System; U.S. Pat. No. 6,449,601, filed Sep. 10, 2002, entitled Distributed Live Auction; U.S. Pat. No. 6,587,838, filed Jul. 1, 2003, entitled Method and System for Conducting Real Time Electronic Commerce; U.S. Pat. No. 6,671,674, filed Dec. 30, 2003, entitled Computer-based Auction and Sale System; U.S. Pat. No. 7,024,376, filed Apr. 4, 2006, entitled Internet-based Auction Method; U.S. Pat. No. 7,085,732, filed Aug. 1, 2006, entitled Online Trading for the Placement of Advertising Media; U.S. Pat. No. 7,162,446, filed Jan. 9, 2007, entitled Integrated Auction; U.S. Pat. No. 7,225,151, filed May 29, 2007, entitled Online Auction Bid Management System and Method; U.S. Pat. No. 7,249,055, filed Jul. 24, 2007, entitled Method and System for Managing and Conducting a Network Auction; U.S. Pat. No. 7,249,085, filed Jul. 24, 2007, entitled Method and System for Conducting Electronic Auctions with Multi-Parameter Price Equalization Bidding; U.S. Pat. No. 7,315,832, filed Jan. 1, 2008, entitled Online Bidding System; U.S. Pat. No. 7,403,915, filed Jul. 22, 2008, entitled Auction System and Method; U.S. Pat. No. 7,089,208, filed Apr. 28, 2000, entitled System and Method for Electronically Exchanging Value Among Distributed Users; U.S. Pat. No. 7,191,151, filed Aug. 23, 2001, entitled Instant Availability of Electronically Transferred Funds; U.S. Pat. No. 7,249,094, filed Feb. 26, 2001, entitled System and Method of Depicting On-Line Transactions; U.S. Pat. No. 7,430,537, filed Jul. 10, 2001, entitled System and Method for Verifying a Financial Instrument; U.S. Pat. No. 5,893,080, filed Apr. 6, 1999, entitled Disbursement System and Method; U.S. Pat. No. 5,963,647, filed Oct. 5, 1999, entitled Method and System for Transferring Funds from an Account to an Individual; U.S. Pat. No. 6,029,151, filed Feb. 22, 2000, entitled Method and System for Performing Electronic Money Transactions; U.S. Pat. No. 6,032,133, filed Feb. 29, 2000, entitled Electronic Bill Pay System; U.S. Pat. No. 6,223,168, filed Apr. 24, 2001, entitled Automatic Remittance Delivery System; U.S. Pat. No. 5,845,265, filed Nov. 7, 1995, entitled Consignment Nodes; U.S. Pat. No. 7,389,251, filed Oct. 21, 1999, entitled Computer-implemented Method for Managing Dynamic Pricing Information; U.S. Ser. No. 10/740,151, filed Dec. 17, 2003, entitled Consignment Nodes; U.S. Ser. No. 11/140,660, filed May 27, 2005, entitled Publication of Informational Messages to Software Applications in a Computing Environment; U.S. Ser. No. 11/888,784, filed Jul. 9, 2004, entitled Method and Apparatus for Securely Displaying and Communicating Trusted and Untrusted Internet Content; U.S. Pat. No. 6,058,417, filed Oct. 23, 1998, entitled, Information Presentation and Management in an Online Trading Environment; U.S. Pat. No. 6,466,917, filed Mar. 9, 2000, entitled, Method and Apparatus for Verifying the Identity of a Participant Within an On-Line Auction Environment; U.S. Pat. No. 7,139,916, filed Jun. 28, 2002, entitled Method and System for Monitoring User Interaction with a Computer; U.S. Pat. No. 7,305,469, filed Dec. 18, 2001, entitled Prioritization of Third Party Access to an Online Commerce Site; U.S. Pat. No. 7,369,505, filed Jun. 7, 2004, entitled, Method and System to Efficiently Manage Network Connection to Connect a Client and a Resource; U.S. Pat. No. 7,233,973, filed Mar. 28, 2005, entitled Evolving Interactive Dialog Box for an Internet Web Page; U.S. Pat. No. 6,944,599, filed Sep. 13, 2000, entitled Monitoring and Automatic Notification of Irregular Activity in a Network-Based Transaction Facility; U.S. Pat. No. 7,373,312, filed Dec. 4, 2000, entitled Method and Apparatus for Facilitating User Registration in an On-Line Auction Environment; U.S. Pat. No. 6,606,608, filed Jul. 19, 1999, entitled Method and System for Providing a Discount at an Auction; U.S. Pat. No. 6,549,904, filed Jun. 25, 1999, entitled Auction Notification System; U.S. Pat. No. 7,428,496, filed Jan. 27, 2006, entitled Creating an Incentive to Author Useful Item Reviews; and U.S. Pat. No. 6,324,526, filed Nov. 27, 2001, entitled System and Method for Performing Secure Credit Card Purchases.

What is claimed is:

1. A method for generating revenue on the internet by an internet content provider, the method comprising the steps of:
a. publishing content on a web page accessible via a web browser;
b. providing on said web page a first area for at least one user-generated default-format comment;
c. providing on said web page a second area for an advertisement;
d. providing on said web page a third area for at least one fee-paid comment;
e. displaying on said web page in said first area at least one of said user-generated default-format comment;
f. displaying on said web page in said second area at least one advertisement;
g. displaying on said web page in said third area at least one fee-paid comment; and
h. wherein readers of said content can read said default-format comment, said advertisement, and said fee-paid comment on the same web page.

2. The method of claim 1, wherein said fee-paid comment is displayed on said web page for a maximum time for a fee received by said internet content provider or a third party associated with said internet content provider.

3. The method of claim 1, wherein said web page displays a news feed.

4. The method of claim 1, wherein said at least one fee-paid comment is in a distinctive position on said web page, being set apart from said at least one free default-format comment.

5. A method for generating revenue on the internet by an internet content provider, the method comprising the steps of:
a. publishing opinion, information, or news stories on a web page accessible for viewing on a mobile device;
b. providing on said web page a portion for containing the expression of user-generated content in a chronological or reverse-chronological order;
c. providing a first area of said portion for displaying a first expression of user-generated content, said first expression containing thoughts or opinion which is displayed for free, and a second area of said portion for displaying a second expression of user-generated content, said second expression containing thoughts or opinion for which a fee was paid, said second area being rendered distinctive relative to said first area;
d. displaying a first expression of user-generated content in said first area;
e. displaying a second expression of user-generated content in said second area after receiving a fee; and
f. wherein a reader of said web page can read said first expression and said second expression on said web page.

6. The method of claim 5, wherein said second area is rendered distinctive relative to said first area by being out of chronological or reverse-chronological order.

7. The method of claim 5, wherein said second area is rendered distinctive relative to said first area by one of a distinctive background, background color, border, border colors, text, text color, text font, text font size, and combinations thereof.

8. The method of claim 5, wherein said first or second expression includes one of text, an image, a URL link or advertising.

9. The method of claim 5, wherein said second expression in said second area is displayed on said web page for a maximum time for a fee received by said internet content provider or a third party associated with said internet content provider.

10. The method of claim 5, wherein a user is prompted by an on screen prompt to pay a fee to modify said user's user generated content to be rendered distinctive.

11. A computer-implemented system for monetizing internet content, the system comprising the steps of:
a. an internet content provider publishing opinion, information, or news stories on a web page accessible for viewing on a mobile device;
b. computer executable instructions for performing the steps comprising:
a. providing on said web page a portion for containing the expression of user-generated content in a chronological or reverse-chronological order;
b. providing a first area of said portion for displaying a first expression of user-generated content, said first expression containing thoughts or opinion which is displayed for free, and a second area of said portion for displaying a second expression of user-generated content, said second expression containing thoughts or opinion for which a fee was paid, said second area being rendered distinctive relative to said first area;
c. displaying a first expression of user-generated content in said first area;
d. displaying a second expression of user-generated content in said second area after receiving a fee; and
e. wherein a reader of said web page can read said first expression and said second expression on said web page;
c. a processor for executing said computer executable instructions; and
d. memory for storing at least said computer executable instructions.

12. The system of claim 11, wherein said second area is rendered distinctive relative to said first area by being out of chronological or reverse-chronological order.

13. The system of claim 11, wherein said second area is rendered distinctive relative to said first area by one of a distinctive background, background color, border, border colors, text, text color, text font, text font size, and combinations thereof.

14. The system of claim 11, wherein said first or second expression includes one of text, an image, a URL link or advertising.

15. The system of claim 11, wherein said second expression in said second area is displayed on said web page for a maximum time for a fee received by said internet content provider or a third party associated with said internet content provider.

16. The system of claim 11, wherein a user is prompted by an on screen prompt to pay a fee to modify said user's user generated content to be rendered distinctive.

17. The system of claim 11, wherein said second expression in said second area does not include an indication of a time of first displaying.
